(19) United States
(12) Patent Application Publication
(10) Pub. No.: US 2025/0392360 A1
(43) Pub. Date: Dec. 25, 2025

(54) CHANNEL STATE INFORMATION (CSI) FEEDBACK REPORTING

(71) Applicant: QUALCOMM Incorporated, San Diego, CA (US)

(72) Inventors: Jing DAI, Beijing (CN); Peter GAAL, San Diego, CA (US); Lei XIAO, San Jose, CA (US); Faris RASSAM, El Cajon, CA (US)

(21) Appl. No.: 18/876,155

(22) PCT Filed: Aug. 12, 2022
(86) PCT No.: PCT/CN2022/112071

§ 371 Date: Dec. 17, 2024

(51) Int. Cl. H04B 7/06; H04L 5/00

(52) U.S. Cl. CPC H04B 7/0626; H04L 5/0048

(57) ABSTRACT

Various aspects generally relate to wireless communication. In some aspects, a user equipment (UE) may utilize a channel state information (CSI) reporting profile index to determine a CSI reporting profile from the index based on at least one of a number of occasions on which a CSI-reference signal (CSI-RS) is received or a time length between two occasions on which a CSI-RS is received. The UE may send a CSI report associated with the determined CSI reporting profile from the index.

### FIELD OF THE DISCLOSURE

The technology discussed below relates generally to wireless communication systems, and more particularly, to techniques and apparatuses for CSI feedback reporting.

### INTRODUCTION

Wireless communication systems are widely deployed to provide various telecommunication services such as telephony, video, data, messaging, and broadcasts. An example telecommunication standard is 5G New Radio (NR). 5G NR is part of a continuous mobile broadband evolution promulgated by Third Generation Partnership Project (3GPP) to meet new requirements associated with latency, reliability, security, scalability (e.g., with Internet of Things (IoT)), and other requirements. In a 5G network, a user equipment can utilize a codebook to determine precoding matrices for beamforming. A precoding matrix may be selected based on channel state information (CSI) feedback reports.

### BRIEF SUMMARY OF SOME EXAMPLES

The following presents a summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a form as a prelude to the more detailed description that is presented later.

Various examples and implementations of the present disclosure facilitate CSI feedback reporting. In at least one aspect of the present disclosure, wireless communication devices are provided. In at least one example, wireless communication device may include a transceiver, a memory, and a processing circuit coupled to the transceiver and the memory. The processing circuit may be configured to obtain an index comprising a plurality of channel state information (CSI) reporting profiles, wherein each CSI reporting profile is associated with at least one of a respective number of occasions on which a CSI-reference signal (CSI-RS) is received during a pre-defined period of time, or a time length between two occasions on which a CSI-RS is received; receive via the transceiver a CSI-RS on at least one occasion over the pre-defined period of time; and send via the transceiver a CSI report associated with a CSI reporting profile selected from the index based on at least one of the number of occasions on which a CSI-RS is received or a time length between two occasions when a CSI-RS is received.

Further aspects provide methods of wireless communication and/or wireless communication devices including means to perform such methods. One or more examples of such methods may include obtaining an index comprising a plurality of channel state information (CSI) reporting profiles, wherein each CSI reporting profile is associated with at least one of a respective number of occasions on which a CSI-reference signal (CSI-RS) is received during a pre-defined period of time, or a time length between two occasions on which a CSI-RS is received; receiving a CSI-RS on at least one occasion over the pre-defined period of time; and sending a CSI report associated with a CSI reporting profile selected from the index based on at least one of the number of occasions on which a CSI-RS is received or a time length between two occasions when a CSI-RS is received.

Still further aspects of the present disclosure include computer-readable storage mediums storing processor-executable programming. In at least one example, the processor-executable programming may be adapted to cause a processing circuit to obtain an index comprising a plurality of channel state information (CSI) reporting profiles, wherein each CSI reporting profile is associated with at least one of a respective number of occasions on which a CSI-reference signal (CSI-RS) is received during a pre-defined period of time, or a time length between two occasions on which a CSI-RS is received; receive via the transceiver a CSI-RS on at least one occasion over the pre-defined period of time; and send via the transceiver a CSI report associated with a CSI reporting profile selected from the index based on at least one of the number of occasions on which a CSI-RS is received or a time length between two occasions when a CSI-RS is received.

These and other aspects of the disclosure will become more fully understood upon a review of the detailed description, which follows. Other aspects, features, and examples of the present invention will become apparent to those of ordinary skill in the art, upon reviewing the following description of specific, exemplary examples in conjunction with the accompanying figures. While features may be discussed relative to certain examples and figures below, all examples can include one or more of the advantageous features discussed herein. In other words, while one or more examples may be discussed as having certain advantageous features, one or more of such features may also be used in accordance with the various examples of the invention discussed herein. In similar fashion, while exemplary examples may be discussed below as device, system, or method examples it should be understood that such exemplary examples can be implemented in various devices, systems, and methods.

### BRIEF DESCRIPTION OF THE DRAWINGS

FIG. 1 is a schematic diagram illustrating an example of a wireless communication system according to some aspects.

FIG. 2 is a conceptual diagram illustrating an example of a radio access network (RAN) according to some aspects.

FIG. 3 is a conceptual diagram illustrating an example of a RAN including distributed entities according to some aspects.

FIG. 4 is a schematic diagram illustrating organization of wireless resources in an air interface utilizing orthogonal frequency divisional multiplexing (OFDM).

FIG. 5 is a schematic diagram illustrating an example of a wireless communication system supporting MIMO.

FIG. 6 is a schematic diagram depicting various reporting and measurement implementations for the Type-II codebook according to some examples.

FIG. 7 is a flow diagram showing operations and communications between a network entity and a UE according to at least one example.

FIG. 8 is a schematic diagram depicting a reporting and measurement implementation for the Type-II codebook according to at least one example.

FIG. 9 is a table diagram illustrating an example of an index with a plurality of CSI reporting profiles.

FIG. 10 is a table diagram illustrating an example of an index with a plurality of CSI reporting profiles.

FIG. 11 is a schematic diagram illustrating the two parts of a CSI report according to at least one example.

FIG. 12 is a block diagram illustrating select components of a wireless communication device according to at least one example of the present disclosure.

FIG. 13 is a flow diagram illustrating a wireless communication method according to some examples.

### DETAILED DESCRIPTION

The detailed description set forth below in connection with the appended drawings is intended as a description of various configurations and is not intended to represent the only configurations in which the concepts described herein may be practiced. The detailed description includes specific details for the purpose of providing a thorough understanding of various concepts. However, it will be apparent to those skilled in the art that these concepts may be practiced without these specific details. In some instances, well known structures and components are shown in block diagram form to avoid obscuring such concepts.

While aspects and embodiments are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, embodiments and/or uses may come about via integrated chip embodiments and other non-module-component based devices (e.g., end-user devices, vehicles, communication devices, computing devices, industrial equipment, retail/purchasing devices, medical devices, AI-enabled devices, etc.). While some examples may or may not be specifically directed to use cases or applications, a wide assortment of applicability of described innovations may occur. Implementations may range a spectrum from chip-level or modular components to non-modular, non-chip-level implementations and further to aggregate, distributed, or OEM devices or systems incorporating one or more aspects of the described innovations. In some practical settings, devices incorporating described aspects and features may also necessarily include additional components and features for implementation and practice of claimed and described embodiments. For example, transmission and reception of wireless signals necessarily includes a number of components for analog and digital purposes (e.g., hardware components including antenna, RF-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

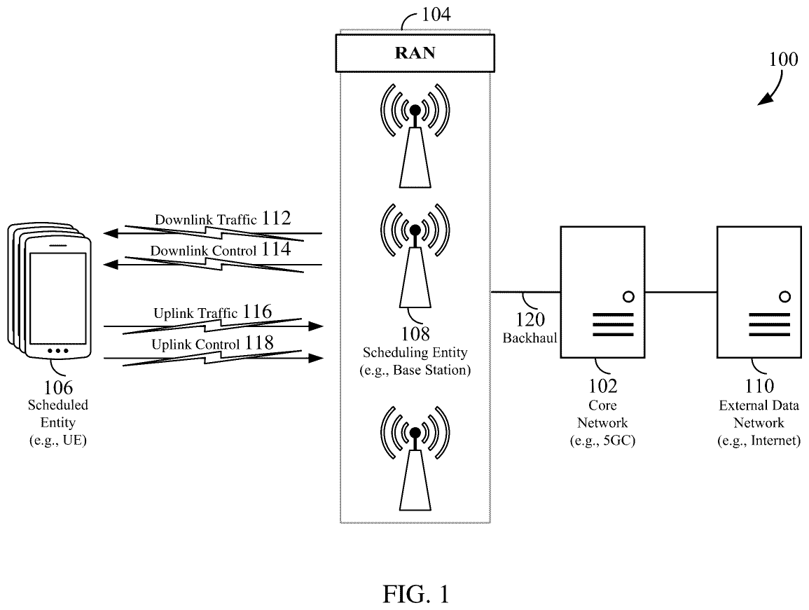

The various concepts presented throughout this disclosure may be implemented across a broad variety of telecommunication systems, network architectures, and communication standards. Referring now to FIG. 1, as an illustrative example without limitation, various aspects of the present disclosure are illustrated with reference to a wireless communication system 100. The wireless communication system 100 includes three interacting domains: a core network 102, a radio access network (RAN) 104, and a user equipment (UE) 106. By virtue of the wireless communication system 100, the UE 106 may be enabled to carry out data communication with an external data network 110, such as (but not limited to) the Internet.

The RAN 104 may implement any suitable wireless communication technology or technologies to provide radio access to the UE 106. As one example, the RAN 104 may operate according to 3^{rd} Generation Partnership Project (3GPP) New Radio (NR) specifications, often referred to as 5G. As another example, the RAN 104 may operate under a hybrid of 5G NR and Evolved Universal Terrestrial Radio Access Network (eUTRAN) standards, often referred to as LTE. The 3GPP refers to this hybrid RAN as a next-generation RAN, or NG-RAN. Of course, many other examples may be utilized within the scope of the present disclosure.

As illustrated, the RAN 104 includes a plurality of base stations 108. Broadly, a base station is a network element in a radio access network responsible for radio transmission and reception in one or more cells to or from a UE. In different technologies, standards, or contexts, a base station may variously be referred to by those skilled in the art as a base transceiver station (BTS), a radio base station, a radio transceiver, a transceiver function, a basic service set (BSS), an extended service set (ESS), an access point (AP), a Node B (NB), an eNode B (eNB), a gNode B (gNB), a transmission and reception point (TRP), or some other suitable terminology. In some examples, a base station may include two or more TRPs that may be collocated or non-collocated. Each TRP may communicate on the same or different carrier frequency within the same or different frequency band.

The radio access network 104 is further illustrated supporting wireless communication for multiple mobile apparatuses. A mobile apparatus may be referred to as user equipment (UE) in 3GPP standards, but may also be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, or some other suitable terminology. A UE may be an apparatus (e.g., a mobile apparatus) that provides a user with access to network services.

Within the present disclosure, a “mobile” apparatus need not necessarily have a capability to move, and may be stationary. The term mobile apparatus or mobile device broadly refers to a diverse array of devices and technologies. UEs may include a number of hardware structural components sized, shaped, and arranged to help in communication; such components can include antennas, antenna arrays, RF chains, amplifiers, one or more processors, etc. electrically coupled to each other. For example, some non-limiting examples of a mobile apparatus include a mobile, a cellular (cell) phone, a smart phone, a session initiation protocol (SIP) phone, a laptop, a personal computer (PC), a notebook, a netbook, a smartbook, a tablet, a personal digital assistant (PDA), and a broad array of embedded systems, e.g., corresponding to an “Internet of things” (IoT). A mobile apparatus may additionally be an automotive or other transportation vehicle, a remote sensor or actuator, a robot or robotics device, a satellite radio, a global positioning system (GPS) device, an object tracking device, a drone, a multi-copter, a quad-copter, a remote control device, a consumer and/or wearable device, such as eyewear, a wearable camera, a virtual reality device, a smart watch, a health or fitness tracker, a digital audio player (e.g., MP3 player), a camera, a game console, etc. A mobile apparatus may additionally be a digital home or smart home device such as a home audio, video, and/or multimedia device, an appliance, a vending machine, intelligent lighting, a home security system, a smart meter, etc. A mobile apparatus may additionally be a smart energy device, a security device, a solar panel or solar array, a municipal infrastructure device controlling electric power (e.g., a smart grid), lighting, water, etc., an industrial automation and enterprise device, a logistics controller, agricultural equipment, vehicles, aircraft, and ships, etc. Still further, a mobile apparatus may provide for connected medicine or telemedicine support, e.g., health care at a distance. Telehealth devices may include telehealth monitoring devices and telehealth administration devices, whose communication may be given preferential treatment or prioritized access over other types of information, e.g., in terms of prioritized access for transport of critical service data, and/or relevant QoS for transport of critical service data.

Wireless communication between the RAN 104 and the UE 106 may be described as utilizing an air interface. Transmissions over the air interface from a network entity (e.g., base station 108) to one or more UEs (e.g., similar to UE 106) may be referred to as downlink (DL) transmission. In accordance with certain aspects of the present disclosure, the term downlink may refer to a point-to-multipoint transmission originating at a network entity (e.g., base station 108). Another way to describe this scheme may be to use the term broadcast channel multiplexing. Transmissions from a UE (e.g., UE 106) to a base station (e.g., base station 108) may be referred to as uplink (UL) transmissions. In accordance with further aspects of the present disclosure, the term uplink may refer to a point-to-point transmission originating at a UE (e.g., UE 106).

In some examples, access to the air interface may be scheduled, wherein a scheduling entity (e.g., a base station 108) allocates resources for communication among some or all devices and equipment within its service area or cell. Within the present disclosure, as discussed further below, the scheduling entity may be responsible for scheduling, assigning, reconfiguring, and releasing resources for one or more scheduled entities (e.g., UEs 106). That is, for scheduled communication, a plurality of UEs 106, which may be scheduled entities, may utilize resources allocated by the scheduling entity 108.

Base stations 108 are not the only entities that may function as scheduling entities. That is, in some examples, a UE may function as a scheduling entity, scheduling resources for one or more scheduled entities (e.g., one or more other UEs). For example, UEs may communicate directly with other UEs in a peer-to-peer or device-to-device fashion and/or in a relay configuration.

As illustrated in FIG. 1, a scheduling entity 108 may broadcast downlink traffic 112 to one or more scheduled entities (e.g., one or more UEs 106). Broadly, the scheduling entity 108 is a node or device responsible for scheduling traffic in a wireless communication network, including the downlink traffic 112 and, in some examples, uplink traffic 116 from one or more scheduled entities (e.g., one or more UEs 106) to the scheduling entity 108. On the other hand, the scheduled entity (e.g., a UE 106) is a node or device that receives downlink control information 114, including but not limited to scheduling information (e.g., a grant), synchronization or timing information, or other control information from another entity in the wireless communication network such as the scheduling entity 108.

In general, base stations 108 may include a backhaul interface for communication with a backhaul portion 120 of the wireless communication system 100. The backhaul portion 120 may provide a link between a base station 108 and the core network 102. Further, in some examples, a backhaul network may provide interconnection between the respective base stations 108. Various types of backhaul interfaces may be employed, such as a direct physical connection, a virtual network, or the like using any suitable transport network.

The core network 102 may be a part of the wireless communication system 100, and may be independent of the radio access technology used in the RAN 104. In some examples, the core network 102 may be configured according to 5G standards (e.g., 5GC). In other examples, the core network 102 may be configured according to a 4G evolved packet core (EPC), or any other suitable standard or configuration.

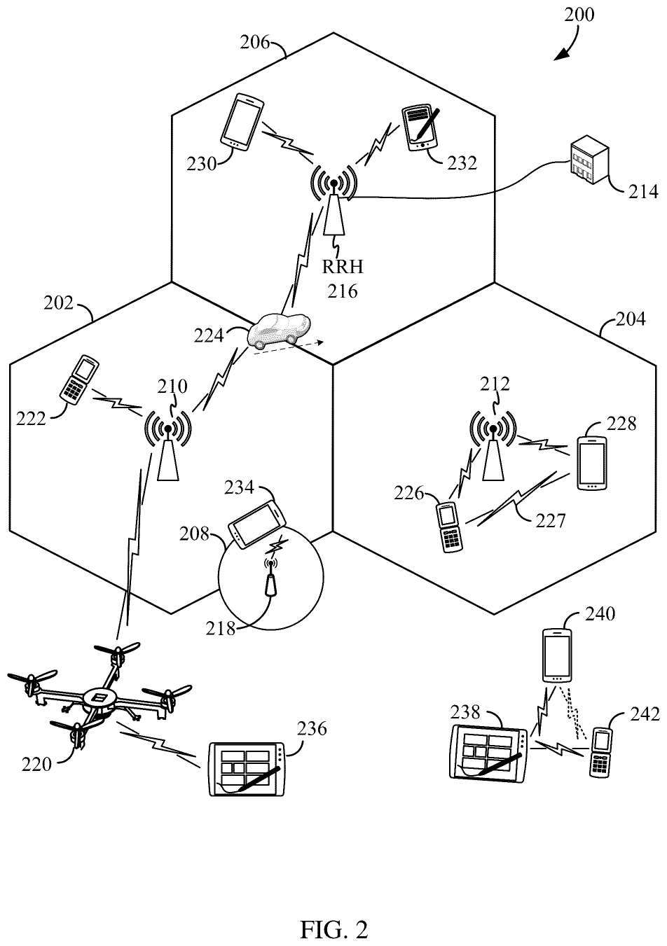

Referring now to FIG. 2, by way of example and without limitation, a schematic illustration of a RAN 200 is provided. In some examples, the RAN 200 may be the same as the RAN 104 described above and illustrated in FIG. 1. The geographic region covered by the RAN 200 may be divided into a number of cellular regions (cells) that can be uniquely identified by a user equipment (UE) based on an identification broadcasted over a geographical area from one access point or base station. FIG. 2 illustrates cells 202, 204, 206, and 208, each of which may include one or more sectors (not shown). A sector is a sub-area of a cell. All sectors within one cell are served by the same base station. A radio link within a sector can be identified by a single logical identification belonging to that sector. In a cell that is divided into sectors, the multiple sectors within a cell can be formed by groups of antennas with each antenna responsible for communication with UEs in a portion of the cell.

Various base station arrangements can be utilized. For example, in FIG. 2, two base stations 210 and 212 are shown in cells 202 and 204. A third base station 214 is shown controlling a remote radio head (RRH) 216 in cell 206. That is, a base station can have an integrated antenna or can be connected to an antenna or RRH 216 by feeder cables. In the illustrated example, the cells 202, 204, and 206 may be referred to as macrocells, as the base stations 210, 212, and 214 support cells having a large size. Further, a base station 218 is shown in the cell 208, which may overlap with one or more macrocells. In this example, the cell 208 may be referred to as a small cell, (e.g., a microcell, picocell, femtocell, home base station, home Node B, home eNode B, etc.), as the base station 218 supports a cell having a relatively small size. Cell sizing can be done according to system design as well as component constraints.

It is to be understood that the RAN 200 may include any number of wireless base stations and cells. Further, a relay node may be deployed to extend the size or coverage area of a given cell. The base stations 210, 212, 214, 218 provide wireless access points to a core network for any number of mobile apparatuses. In some examples, the base stations 210, 212, 214, and/or 218 may be the same as or similar to the scheduling entity 108 described above and illustrated in FIG. 1.

FIG. 2 further includes an unmanned aerial vehicle (UAV) 220, which may be a drone or quadcopter. The UAV 220 may be configured to function as a base station, or more specifically as a mobile base station. That is, in some examples, a cell may not necessarily be stationary, and the geographic area of the cell may move according to the location of a mobile base station, such as the UAV 220.

Within the RAN 200, the cells may include UEs that may be in communication with one or more sectors of each cell. Further, each base station 210, 212, 214, 218, and 220 may be configured to provide an access point to a core network 102 (see FIG. 1) for all the UEs in the respective cells. For example, UEs 222 and 224 may be in communication with base station 210, UEs 226 and 228 may be in communication with base station 212, UEs 230 and 232 may be in communication with base station 214 by way of RRH 216, UE 234 may be in communication with base station 218, and UE 236 may be in communication with mobile base station 220. In some examples, the UEs 222, 224, 226, 228, 230, 232, 234, 236, 238, 240, and/or 242 may be the same as or similar to the UE/scheduled entity 106 described above and illustrated in FIG. 1.

In some examples, the UAV 220 (e.g., the quadcopter) can be a mobile network node and may be configured to function as a UE. For example, the UAV 220 may operate within cell 202 by communicating with base station 210.

In a further aspect of the RAN 200, sidelink signals may be used between UEs without necessarily relying on scheduling or control information from a base station. Sidelink communication may be utilized, for example, in a device-to-device (D2D) network, peer-to-peer (P2P) network, vehicle-to-vehicle (V2V) network, vehicle-to-everything (V2X) network, and/or other suitable sidelink network. For example, two or more UEs (e.g., UEs 238, 240, and 242) may communicate with each other using sidelink signals 237 without relaying that communication through a base station. In some examples, the UEs 238, 240, and 242 may each function as a scheduling entity or transmitting sidelink device and/or a scheduled entity or a receiving sidelink device to schedule resources and communicate sidelink signals 237 therebetween without relying on scheduling or control information from a base station. In other examples, two or more UEs (e.g., UEs 226 and 228) within the coverage area of a base station (e.g., base station 212) may also communicate sidelink signals 227 over a direct link (sidelink) without conveying that communication through the base station 212. In this example, the base station 212 may allocate resources to the UEs 226 and 228 for the sidelink communication.

In some examples, a D2D relay framework may be included within a cellular network to facilitate relaying of communication to/from the base station 212 via D2D links (e.g., sidelinks 227 or 237). For example, one or more UEs (e.g., UE 228) within the coverage area of the base station 212 may operate as relaying UEs to extend the coverage of the base station 212, improve the transmission reliability to one or more UEs (e.g., UE 226), and/or to allow the base station to recover from a failed UE link due to, for example, blockage or fading.

In the radio access network 200, the ability for a UE to communicate while moving, independent of its location, is referred to as mobility. The various physical channels between the UE and the radio access network are generally set up, maintained, and released under the control of an access and mobility management function (AMF, not illustrated, part of the core network 102 in FIG. 1), which may include a security context management function (SCMF) that manages the security context for both the control plane and the user plane functionality, and a security anchor function (SEAF) that performs authentication.

In some examples, the base stations 210, 212, and 214/216 may broadcast unified synchronization signals (e.g., unified Primary Synchronization Signals (PSSs), unified Secondary Synchronization Signals (SSSs) and unified Physical Broadcast Channels (PBCH)). The UEs 222, 224, 226, 228, 230, and 232 may receive the unified synchronization signals, derive the carrier frequency and slot timing from the synchronization signals, and in response to deriving timing, transmit an uplink pilot or reference signal. The uplink pilot signal transmitted by a UE (e.g., UE 224) may be concurrently received by two or more cells (e.g., base stations 210 and 214/216) within the radio access network 200. Each of the cells may measure a strength of the pilot signal, and the radio access network (e.g., one or more of the base stations 210 and 214/216 and/or a central node within the core network) may determine a serving cell for the UE 224. As the UE 224 moves through the radio access network 200, the network may continue to monitor the uplink pilot signal transmitted by the UE 224. When the signal strength or quality of the pilot signal measured by a neighboring cell exceeds that of the signal strength or quality measured by the serving cell, the network 200 may handover the UE 224 from the serving cell to the neighboring cell, with or without informing the UE 224.

Although the synchronization signal transmitted by the base stations 210, 212, and 214/216 may be unified, the synchronization signal may not identify a particular cell, but rather may identify a zone of multiple cells operating on the same frequency and/or with the same timing. The use of zones in 5G networks or other next generation communication networks enables the uplink-based mobility framework and improves the efficiency of both the UE and the network, since the number of mobility messages that need to be exchanged between the UE and the network may be reduced.

Deployment of communication systems, such as 5G new radio (NR) systems, may be arranged in multiple manners with various components or constituent parts. In a 5G NR system, or network, a network node, a network entity, a mobility element of a network, a radio access network (RAN) node, a core network node, a network element, or a network equipment, such as a base station (BS), or one or more units (or one or more components) performing base station functionality, may be implemented in an aggregated or disaggregated architecture. For example, a BS (such as a Node B (NB), evolved NB (eNB), NR BS, 5G NB (gNB), access point (AP), a transmit receive point (TRP), or a cell, etc.) may be implemented as an aggregated base station (also known as a standalone BS or a monolithic BS) or a disaggregated base station.

An aggregated base station may be configured to utilize a radio protocol stack that is physically or logically integrated within a single RAN node. A disaggregated base station may be configured to utilize a protocol stack that is physically or logically distributed among two or more units (such as one or more central or centralized units (CUs), one or more distributed units (DUs), or one or more radio units (RUs)). In some aspects, a CU may be implemented within a RAN node, and one or more DUs may be co-located with the CU, or alternatively, may be geographically or virtually distributed throughout one or multiple other RAN nodes. The DUs may be implemented to communicate with one or more RUs. Each of the CU, DU and RU also can be implemented as virtual units, i.e., a virtual central unit (VCU), a virtual distributed unit (VDU), or a virtual radio unit (VRU).

Base station-type operation or network design may consider aggregation characteristics of base station functionality. For example, disaggregated base stations may be utilized in an integrated access backhaul (IAB) network, an open radio access network (O-RAN (such as the network configuration sponsored by the O-RAN Alliance)), or a virtualized radio access network (vRAN, also known as a cloud radio access network (C-RAN)). Disaggregation may include distributing functionality across two or more units at various physical locations, as well as distributing functionality for at least one unit virtually, which can enable flexibility in network design. The various units of the disaggregated base station, or disaggregated RAN architecture, can be configured for wired or wireless communication with at least one other unit.

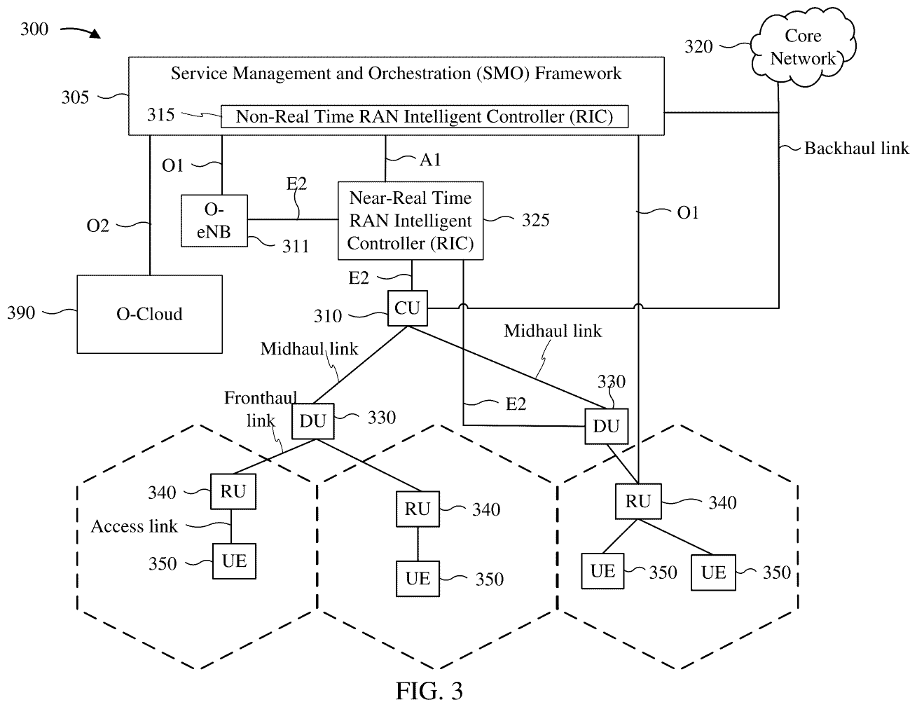

FIG. 3 shows a diagram illustrating an example disaggregated base station 300 architecture. The disaggregated base station 300 architecture may include one or more central units (CUs) 310 that can communicate directly with a core network 320 via a backhaul link, or indirectly with the core network 320 through one or more disaggregated base station units (such as a Near-Real Time (Near-RT) RAN Intelligent Controller (RIC) 325 via an E2 link, or a Non-Real Time (Non-RT) RIC 315 associated with a Service Management and Orchestration (SMO) Framework 305, or both). A CU 310 may communicate with one or more distributed units (DUs) 330 via respective midhaul links, such as an F1 interface. The DUs 330 may communicate with one or more radio units (RUs) 340 via respective fronthaul links. The RUs 340 may communicate with respective UEs 350 via one or more radio frequency (RF) access links. In some implementations, the UE 350 may be simultaneously served by multiple RUs 340.

Each of the units, i.e., the CUS 310, the DUs 330, the RUs 340, as well as the Near-RT RICs 325, the Non-RT RICs 315 and the SMO Framework 305, may include one or more interfaces or be coupled to one or more interfaces configured to receive or transmit signals, data, or information (collectively, signals) via a wired or wireless transmission medium. Each of the units, or an associated processor or controller providing instructions to the communication interfaces of the units, can be configured to communicate with one or more of the other units via the transmission medium. For example, the units can include a wired interface configured to receive or transmit signals over a wired transmission medium to one or more of the other units. Additionally, the units can include a wireless interface, which may include a receiver, a transmitter or transceiver (such as a radio frequency (RF) transceiver), configured to receive or transmit signals, or both, over a wireless transmission medium to one or more of the other units.

In some aspects, the CU 310 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 310. The CU 310 may be configured to handle user plane functionality (i.e., Central Unit-User Plane (CU-UP)), control plane functionality (i.e., Central Unit-Control Plane (CU-CP)), or a combination thereof. In some implementations, the CU 310 can be logically split into one or more CU-UP units and one or more CU-CP units. The CU-UP unit can communicate bidirectionally with the CU-CP unit via an interface, such as the E1 interface when implemented in an O-RAN configuration. The CU 310 can be implemented to communicate with the DU 330, as necessary, for network control and signaling.

The DU 330 may correspond to a logical unit that includes one or more base station functions to control the operation of one or more RUs 340. In some aspects, the DU 330 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 330 may further host one or more low PHY layers. Each layer (or module) can be implemented with an interface configured to communicate signals with other layers (and modules) hosted by the DU 330, or with the control functions hosted by the CU 310.

Lower-layer functionality can be implemented by one or more RUs 340. In some deployments, an RU 340, controlled by a DU 330, may correspond to a logical node that hosts RF processing functions, or low-PHY layer functions (such as performing fast Fourier transform (FFT), inverse FFT (IFFT), digital beamforming, physical random access channel (PRACH) extraction and filtering, or the like), or both, based at least in part on the functional split, such as a lower layer functional split. In such an architecture, the RU(s) 340 can be implemented to handle over the air (OTA) communication with one or more UEs 350. In some implementations, real-time and non-real-time aspects of control and user plane communication with the RU(s) 340 can be controlled by the corresponding DU 330. In some scenarios, this configuration can enable the DU(s) 330 and the CU 310 to be implemented in a cloud-based RAN architecture, such as a vRAN architecture.

The SMO Framework 305 may be configured to support RAN deployment and provisioning of non-virtualized and virtualized network elements. For non-virtualized network elements, the SMO Framework 305 may be configured to support the deployment of dedicated physical resources for RAN coverage requirements which may be managed via an operations and maintenance interface (such as an O1 interface). For virtualized network elements, the SMO Framework 305 may be configured to interact with a cloud computing platform (such as an open cloud (O-Cloud) 390) to perform network element life cycle management (such as to instantiate virtualized network elements) via a cloud computing platform interface (such as an O2 interface). Such virtualized network elements can include, but are not limited to, CUs 310, DUs 330, RUs 340 and Near-RT RICs 325. In some implementations, the SMO Framework 305 can communicate with a hardware aspect of a 4G RAN, such as an open eNB (O-eNB) 311, via an O1 interface. Additionally, in some implementations, the SMO Framework 305 can communicate directly with one or more RUs 340 via an O1 interface. The SMO Framework 305 also may include a Non-RT RIC 315 configured to support functionality of the SMO Framework 305.

The Non-RT RIC 315 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 325. The Non-RT RIC 315 may be coupled to or communicate with (such as via an A1 interface) the Near-RT RIC 325. The Near-RT RIC 325 may be configured to include a logical function that enables near-real-time control and optimization of RAN elements and resources via data collection and actions over an interface (such as via an E2 interface) connecting one or more CUs 310, one or more DUs 330, or both, as well as an O-eNB, with the Near-RT RIC 325.

In some implementations, to generate AI/ML models to be deployed in the Near-RT RIC 325, the Non-RT RIC 315 may receive parameters or external enrichment information from external servers. Such information may be utilized by the Near-RT RIC 325 and may be received at the SMO Framework 305 or the Non-RT RIC 315 from non-network data sources or from network functions. In some examples, the Non-RT RIC 315 or the Near-RT RIC 325 may be configured to tune RAN behavior or performance. For example, the Non-RT RIC 315 may monitor long-term trends and patterns for performance and employ AI/ML models to perform corrective actions through the SMO Framework 305 (such as reconfiguration via O1) or via creation of RAN management policies (such as A1 policies).

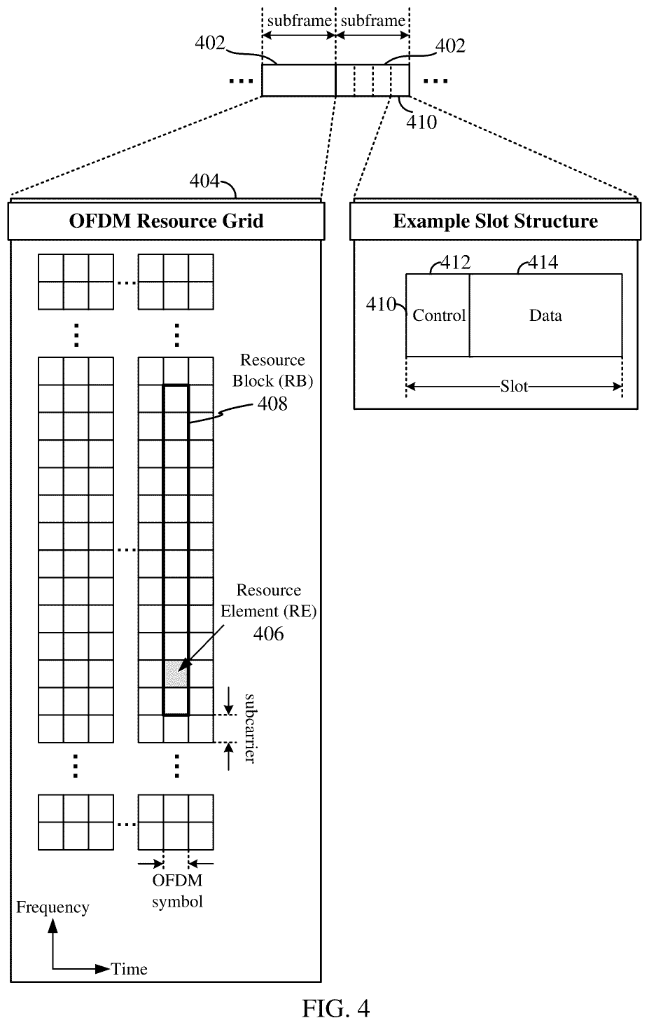

Various aspects of the present disclosure will be described with reference to an OFDM waveform, schematically illustrated in FIG. 4. It should be understood by those of ordinary skill in the art that the various aspects of the present disclosure may be applied to an SC-FDMA waveform in substantially the same way as described herein below. That is, while some examples of the present disclosure may focus on an OFDM link for clarity, it should be understood that the same principles may be applied as well to SC-FDMA waveforms.

Within the present disclosure, a frame refers to a duration of 10 ms for wireless transmissions, with each frame consisting of 10 subframes of 1 ms each. On a given carrier, there may be one set of frames in the UL, and another set of frames in the DL. Referring now to FIG. 4, an expanded view of an exemplary DL subframe 402 is illustrated, showing an OFDM resource grid 404. However, as those skilled in the art will readily appreciate, the PHY transmission structure for any particular application may vary from the example described here, depending on any number of factors. Here, time is in the horizontal direction with units of OFDM symbols; and frequency is in the vertical direction with units of subcarriers or tones.

The resource grid 404 may be used to schematically represent time-frequency resources for a given antenna port. That is, in a MIMO implementation with multiple antenna ports available, a corresponding multiple number of resource grids 404 may be available for communication. The resource grid 404 is divided into multiple resource elements (REs) 406. An RE, which is 1 subcarrier×1 symbol, is the smallest discrete part of the time-frequency grid, and contains a single complex value representing data from a physical channel or signal. Depending on the modulation utilized in a particular implementation, each RE may represent one or more bits of information. In some examples, a block of REs may be referred to as a physical resource block (PRB) or more simply a resource block (RB) 408, which contains any suitable number of consecutive subcarriers in the frequency domain. In one example, an RB may include 12 subcarriers, a number independent of the numerology used. In some examples, depending on the numerology, an RB may include any suitable number of consecutive OFDM symbols in the time domain. Within the present disclosure, it is assumed that a single RB such as the RB 408 entirely corresponds to a single direction of communication (either transmission or reception for a given device).

A set of continuous or discontinuous resource blocks may be referred to herein as a Resource Block Group (RBG), sub-band, or bandwidth part (BWP). A set of sub-bands or BWPs may span the entire bandwidth. Scheduling of scheduled entities (e.g., UEs) for downlink, uplink, or sidelink transmissions typically involves scheduling one or more resource elements 406 within one or more sub-bands or bandwidth parts (BWPs). Thus, a UE generally utilizes only a subset of the resource grid 404. In some examples, an RB may be the smallest unit of resources that can be allocated to a UE. Thus, the more RBs scheduled for a UE, and the higher the modulation scheme chosen for the air interface, the higher the data rate for the UE. The RBs may be scheduled by a scheduling entity, such as a base station (e.g., gNB, eNB, etc.), or may be self-scheduled by a UE implementing D2D sidelink communication.

In this illustration, the RB 408 is shown as occupying less than the entire bandwidth of the subframe 402, with some subcarriers illustrated above and below the RB 408. In a given implementation, the subframe 402 may have a bandwidth corresponding to any number of one or more RBs 408. Further, in this illustration, the RB 408 is shown as occupying less than the entire duration of the subframe 402, although this is merely one possible example.

Each subframe 402 (e.g., a 1 ms subframe) may consist of one or multiple adjacent slots. In the example shown in FIG. 4, one subframe 402 includes four slots 410, as an illustrative example. In some examples, a slot may be defined according to a specified number of OFDM symbols with a given cyclic prefix (CP) length. For example, a slot may include 7 or 14 OFDM symbols with a nominal CP. Additional examples may include mini-slots, sometimes referred to as shortened transmission time intervals (TTIs), having a shorter duration (e.g., one to three OFDM symbols). These mini-slots or shortened transmission time intervals (TTIs) may in some cases be transmitted occupying resources scheduled for ongoing slot transmissions for the same or for different UEs. Any number of resource blocks may be utilized within a subframe or slot.

An expanded view of one of the slots 410 illustrates the slot 410 including a control region 412 and a data region 414. In general, the control region 412 may carry control channels (e.g., PDCCH), and the data region 414 may carry data channels (e.g., PDSCH or PUSCH). Of course, a slot may contain all DL, all UL, or at least one DL portion and at least one UL portion. The simple structure illustrated in FIG. 4 is merely exemplary in nature, and different slot structures may be utilized, and may include one or more of each of the control region(s) and data region(s).

Although not illustrated in FIG. 4, the various REs 406 within a RB 408 may be scheduled to carry one or more physical channels, including control channels, shared channels, data channels, etc. Other REs 406 within the RB 408 may also carry pilots or reference signals. These pilots or reference signals may provide for a receiving device to perform channel estimation of the corresponding channel, which may enable coherent demodulation/detection of the control and/or data channels within the RB 408.

In some examples, the slot 410 may be utilized for broadcast, multicast, groupcast, or unicast communication. For example, a broadcast, multicast, or groupcast communication may refer to a point-to-multipoint transmission by one device (e.g., a base station, UE, or other similar device) to other devices. Here, a broadcast communication is delivered to all devices, whereas a multicast or groupcast communication is delivered to multiple intended recipient devices. A unicast communication may refer to a point-to-point transmission by a one device to a single other device.

In an example of cellular communication over a cellular carrier via a Uu interface, for a DL transmission, the scheduling entity (e.g., a base station) may allocate one or more REs 406 (e.g., within the control region 412) to carry DL control information including one or more DL control channels, such as a physical downlink control channel (PDCCH), to one or more scheduled entities (e.g., UEs). The PDCCH carries downlink control information (DCI) including but not limited to power control commands (e.g., one or more open loop power control parameters and/or one or more closed loop power control parameters), scheduling information, a grant, and/or an assignment of REs for DL and UL transmissions. The PDCCH may further carry HARQ feedback transmissionsU such as an acknowledgment (ACK) or negative acknowledgment (NACK). HARQ is a technique well-known to those of ordinary skill in the art, wherein the integrity of packet transmissions may be checked at the receiving side for accuracy, e.g., utilizing any suitable integrity checking mechanism, such as a checksum or a cyclic redundancy check (CRC). If the integrity of the transmission is confirmed, an ACK may be transmitted, whereas if not confirmed, a NACK may be transmitted. In response to a NACK, the transmitting device may send a HARQ retransmission, which may implement chase combining, incremental redundancy, etc.

The base station may further allocate one or more REs 406 (e.g., in the control region 412 or the data region 414) to carry other DL signals, such as a demodulation reference signal (DMRS); a phase-tracking reference signal (PT-RS); a channel state information (CSI) reference signal (CSI-RS); and a synchronization signal block (SSB). SSBs may be broadcast at regular intervals based on a periodicity (e.g., 5, 10, 20, 30, 80, or 130 ms). An SSB includes a primary synchronization signal (PSS), a secondary synchronization signal (SSS), and a physical broadcast control channel (PBCH). A UE may utilize the PSS and SSS to achieve radio frame, subframe, slot, and symbol synchronization in the time domain, identify the center of the channel (system) bandwidth in the frequency domain, and identify the physical cell identity (PCI) of the cell.

The PBCH in the SSB may further include a master information block (MIB) that includes various system information, along with parameters for decoding a system information block (SIB). The SIB may be, for example, a SystemInformationType 1 (SIB1) that may include various additional system information. The MIB and SIB1 together provide the minimum system information (SI) for initial access. Examples of system information transmitted in the MIB may include, but are not limited to, a subcarrier spacing (e.g., default downlink numerology), system frame number, a configuration of a PDCCH control resource set (CORESET) (e.g., PDCCH CORESET0), a cell barred indicator, a cell reselection indicator, a raster offset, and a search space for SIB1. Examples of remaining minimum system information (RMSI) transmitted in the SIB1 may include, but are not limited to, a random access search space, a paging search space, downlink configuration information, and uplink configuration information. A base station may transmit other system information (OSI) as well.

In an UL transmission, the scheduled entity (e.g., UE) may utilize one or more REs 406 to carry UL control information (UCI) including one or more UL control channels, such as a physical uplink control channel (PUCCH), to the scheduling entity. UCI may include a variety of packet types and categories, including pilots, reference signals, and information configured to enable or assist in decoding uplink data transmissions. Examples of uplink reference signals may include a sounding reference signal (SRS) and an uplink DMRS. In some examples, the UCI may include a scheduling request (SR), i.e., request for the scheduling entity to schedule uplink transmissions. Here, in response to the SR transmitted on the UCI, the scheduling entity may transmit downlink control information (DCI) that may schedule resources for uplink packet transmissions. UCI may also include HARQ feedback, channel state feedback (CSF), such as a CSI report, or any other suitable UCI.

In addition to control information, one or more REs 406 (e.g., within the data region 414) may be allocated for data traffic. Such data traffic may be carried on one or more traffic channels, such as, for a DL transmission, a physical downlink shared channel (PDSCH); or for an UL transmission, a physical uplink shared channel (PUSCH). In some examples, one or more REs 406 within the data region 414 may be configured to carry other signals, such as one or more SIBs and DMRSs. In some examples, the PDSCH may carry a plurality of SIBs, not limited to SIB1, discussed above. For example, the OSI may be provided in these SIBs, e.g., SIB2 and above.

These physical channels described above are generally multiplexed and mapped to transport channels for handling at the medium access control (MAC) layer. Transport channels carry blocks of information called transport blocks (TB). The transport block size (TBS), which may correspond to a number of bits of information, may be a controlled parameter, based on the modulation and coding scheme (MCS) and the number of RBs in a given transmission.

The channels or carriers illustrated in FIG. 4 are not necessarily all of the channels or carriers that may be utilized between devices, and those of ordinary skill in the art will recognize that other channels or carriers may be utilized in addition to those illustrated, such as other traffic, control, and feedback channels.

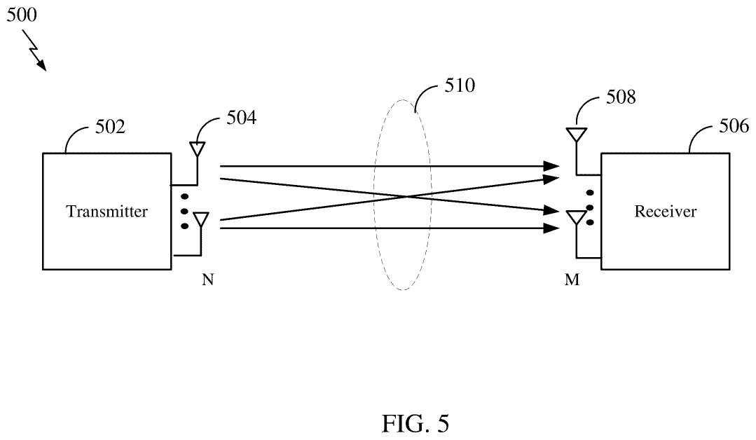

In some aspects of the disclosure, the scheduling entity and/or scheduled entity may be configured for beamforming and/or multiple-input multiple-output (MIMO) technology. FIG. 5 illustrates an example of a wireless communication system 500 supporting MIMO. In a MIMO system, a transmitter 502 includes multiple transmit antennas 504 (e.g., N transmit antennas) and a receiver 506 includes multiple receive antennas 508 (e.g., M receive antennas). Thus, there are N×M signal paths 510 from the transmit antennas 504 to the receive antennas 508. Each of the transmitter 502 and the receiver 506 may be implemented, for example, within a scheduling entity 108, a scheduled entity 106, or any other suitable wireless communication device.

The use of such multiple antenna technology enables the wireless communication system to exploit the spatial domain to support spatial multiplexing, beamforming, and transmit diversity. Spatial multiplexing may be used to transmit different streams of data, also referred to as layers, simultaneously on the same time-frequency resource. The data streams may be transmitted to a single UE to increase the data rate or to multiple UEs to increase the overall system capacity, the latter being referred to as multi-user MIMO (MU-MIMO). This is achieved by spatially precoding each data stream (i.e., multiplying the data streams with different weighting and phase shifting) and then transmitting each spatially precoded stream through multiple transmit antennas on the downlink. The spatially precoded data streams arrive at the UE(s) with different spatial signatures, which enables each of the UE(s) to recover the one or more data streams destined for that UE. On the uplink, each UE transmits a spatially precoded data stream, which enables the base station to identify the source of each spatially precoded data stream.

The number of data streams or layers corresponds to the rank of the transmission. In general, the rank of the MIMO system 500 is limited by the number of transmit or receive antennas 504 or 508, whichever is lower. In addition, the channel conditions at the UE, as well as other considerations, such as the available resources at the base station, may also affect the transmission rank. For example, the rank (and therefore, the number of data streams) assigned to a particular UE on the downlink may be determined based on the rank indicator (RI) transmitted from the UE to the base station. The RI may be determined based on the antenna configuration (e.g., the number of transmit and receive antennas) and a measured signal-to-interference-and-noise ratio (SINR) on each of the receive antennas. The RI may indicate, for example, the number of layers that may be supported under the current channel conditions. The base station may use the RI, along with resource information (e.g., the available resources and amount of data to be scheduled for the UE), to assign a transmission rank to the UE.

In Time Division Duplex (TDD) systems, the UL and DL are reciprocal, in that each uses different time slots of the same frequency bandwidth. Therefore, in TDD systems, the base station may assign the rank for DL MIMO transmissions based on UL SINR measurements (e.g., based on a Sounding Reference Signal (SRS) transmitted from the UE or other pilot signal). Based on the assigned rank, the base station may then transmit the CSI-RS with separate C-RS sequences for each layer to provide for multi-layer channel estimation. From the CSI-RS, the UE may measure the channel quality across layers and resource blocks and feed back the RI and a channel quality indicator (CQI) that indicates to the base station a modulation and coding scheme (MCS) to use for transmissions to the UE for use in updating the rank and assigning REs for future downlink transmissions.

In the simplest case, as shown in FIG. 5, a rank-2 spatial multiplexing transmission on a 2×2 MIMO antenna configuration will transmit one data stream from each transmit antenna 504. Each data stream reaches each receive antenna 508 along a different signal path 510. The receiver 506 may then reconstruct the data streams using the received signals from each receive antenna 508.

Beamforming is a signal processing technique that may be used at the transmitter 502 or receiver 506 to shape or steer an antenna beam (e.g., a transmit beam or receive beam) along a spatial path between the transmitter 502 and the receiver 506. Beamforming may be achieved by combining the signals communicated via antennas 504 or 508 (e.g., antenna elements of an antenna array module) such that some of the signals experience constructive interference while others experience destructive interference. To create the desired constructive/destructive interference, the transmitter 502 or receiver 506 may apply amplitude and/or phase offsets to signals transmitted or received from each of the antennas 504 or 508 associated with the transmitter 502 or receiver 506.

The electromagnetic spectrum is often subdivided, based on frequency/wavelength, into various classes, bands, channels, etc. In 5G NR two initial operating bands have been identified as frequency range designations FRI (410 MHz-7.125 GHz) and FR2 (24.25 GHz-52.6 GHz). It should be understood that although a portion of FR1 is greater than 6 GHz, FRI is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

The frequencies between FR1 and FR2 are often referred to as mid-band frequencies. Recent 5G NR studies have identified an operating band for these mid-band frequencies as frequency range designation FR3 (7.125 GHz-24.25 GHz). Frequency bands falling within FR3 may inherit FR1 characteristics and/or FR2 characteristics, and thus may effectively extend features of FR1 and/or FR2 into mid-band frequencies. In addition, higher frequency bands are currently being explored to extend 5G NR operation beyond 52.6 GHz. For example, three higher operating bands have been identified as frequency range designations FR4-a or FR4-1 (52.6 GHZ-71 GHz), FR4 (52.6 GHz-114.25 GHZ), and FR5 (114.25 GHz-300 GHz). Each of these higher frequency bands falls within the EHF band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, FR4, FR4-a or FR4-1, and/or FR5, or may be within the EHF band.

As noted above, a UE operating within a network, such as radio access network 200 and/or radio access network 300, may utilize each received CSI-RS to measure the channel quality (e.g., the SINR and/or RSRP) and generate a CSI report based on the measured channel quality. The CSI report may include, for example, a channel quality indicator (CQI), rank indicator (RI), precoding matrix indicator (PMI), and/or layer indicator (LI). The network entity (e.g., gNB) may use the CSI report to select a rank for the UE, along with a precoding matrix and a MCS to use for future downlink transmissions to the UE. The MCS may be selected from one or more MCS tables, each associated with a particular type of coding (e.g., polar coding, LDPC, etc.) or modulation (e.g., binary phase shift keying (BPSK), quadrature phase shift keying (QPSK), 16 quadrature amplitude modulation (QAM), 64 QAM, 256 QAM, etc.). The LI may be utilized to indicate which column of the precoding matrix of the reported PMI corresponds to the strongest layer codeword corresponding to the largest reported wideband CQI.

In 5G NR, a RAN may utilize two types of codebooks, referred to generally as Type I and Type II. In Release 16 of the 3GPP standards, a Type-II precoding matrix may be defined by the equation W=W₁×\tilde{W}₂×W_{f}^{H}. The variable W₁ refers to spatial domain bases, such as the beams of the antenna panel. The variable W_{f} refers to the frequency domain bases, which may take into account the multiple paths and delay. The variable \tilde{W}₂ refers to the matrix coefficient.

For stationary UEs, the results from the above formula may remain relatively unchanged over time. When a UE is mobile, however, the results may change relatively quickly, especially as the velocity of the UE increases. In relatively fast varying examples due to the velocity of the UE, it has been proposed to utilize the formula W(n)=W₁×\tilde{W}₂(n)×W_{f}^{H} for a Type-II precoding matrix, where ‘n’ refers to the time instance. It may be noted that the spatial domain ‘W’ and frequency domain bases ‘W_{f}’ are assumed to be relatively constant over a short time period in this proposed formula, even in relatively high-velocity UEs. In some examples, the UE may perform a compression of the CSI-RS observations over a period of time, and may report the CSI-RS observations to the network entity (e.g., gNB) where the network entity extrapolates the reported CSI-RS observations to predict the precoder for a future period of time. In other examples, the UE may report both the CSI-RS observations and extrapolations for precoder predictions to the network entity (e.g., gNB).

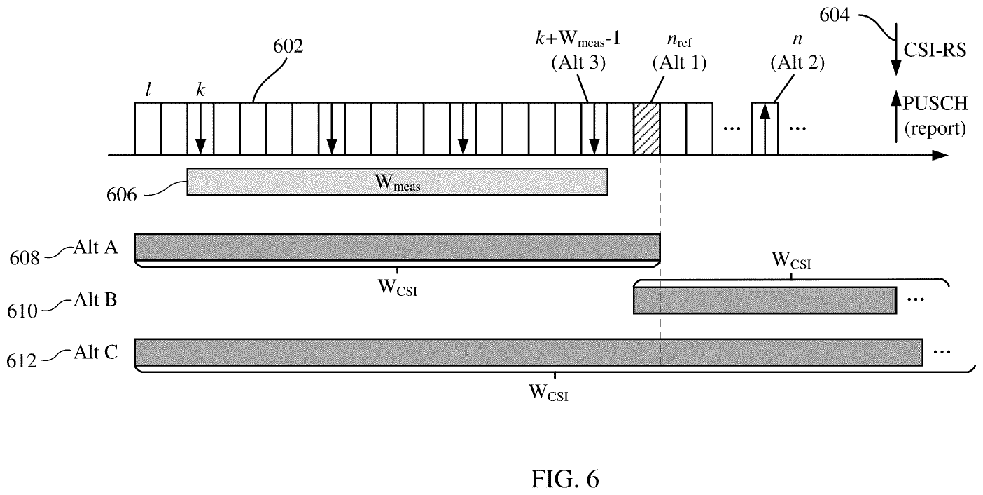

Referring to FIG. 6, a schematic diagram is shown depicting various reporting and measurement implementations for the Type-II codebook according to some examples. In FIG. 6, a plurality of consecutive slots 602 are depicted in a time domain from left to right. CSI-RS occasions 604 may occur within particular slots 602. A CSI measurement window Wₘₑₐₛ 606 and three alternatives for CSI reporting windows W_{CSI} are also depicted. The CSI measurement window Wₘₑₐₛ 606 represents the window in which the UE measures the occasions 604 on which a CSI-RS is received for calculating a CSI report. In the example depicted in FIG. 6, ‘k’ represents a slot index for the CSI measurement window Wₘₑₐₛ 606 with the CSI measurement window Wₘₑₐₛ 606 having a specified length in slots from the slot index ‘k.’ The CSI reporting window W_{CSI} is associated with a slot index ‘l’ and a predetermined boundary slot. In the depicted examples of the CSI reporting window W_{CSI}, the predetermined boundary slot is a CSI reference resource slot, depicted as n_{ref}. In other implementations, the predetermined boundary slot may be a PUSCH slot ‘n’ or a last slot of the measurement window ‘k+Wₘₑₐₛ−1.’ It should be understood that these are examples of the predetermined boundary slot, and other boundary slots may be utilized as desired.

In the example of FIG. 6, the first alternative, Alt A 608, depicts an example where the CSI reporting window is associated only with observed occasions 604 with a received CSI-RS. The second alternative, Alt B 610, depicts an example where the CSI reporting window is associated only with future occasions 604 for CSI-RS, and represents a predictive nature of CSI-RS. Finally, the third alternative, Alt C 612, depicts an example where the CSI reporting window is associated with both observed occasions 604 and future occasions 604 for CSI-RS.

In some instances, the UE may be unable to receive all of the CSI-RSs on each occasion during a CSI measurement window Wₘₑₐₛ 606 or CSI reporting window W_{CSI}. For example, a UE may be unable to receive a CSI-RS occasion 604 due to one or more of an UL conflict with a CSI-RS occasion 604, a BWP change, serving cell activation, CSI-related RRC configuration and reconfiguration, activation of semi-persistent (SP)-report, discontinuous reception (DRX), etc. In such instances when one or more CSI-RS occasions 604 is not received by the UE, the ability to predict/extrapolate channel quality for future code matrices can be hindered. For example, the predicted/extrapolated channel quality can vary based on the number of CSI-RS occasions 604 received, the total length of time between received CSI-RS occasions 604, etc. According to one or more aspects of the present disclosure, a UE is adapted to select a CSI report in response to the number of CSI-RS occasions 604 received and/or a length of time between two or more received CSI-RS occasions 604.

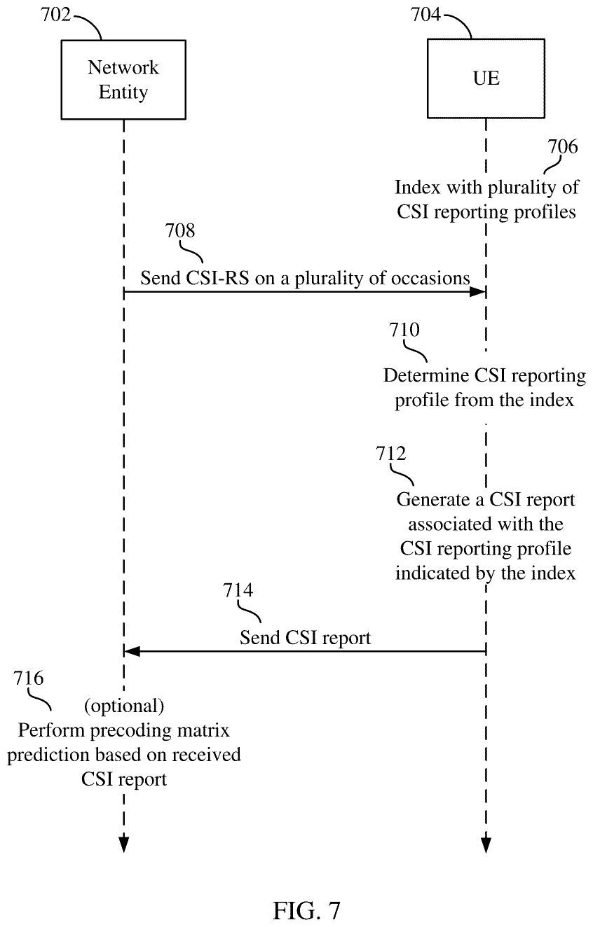

Referring to FIG. 7, a flow diagram is depicted showing operations and communications between a network entity (e.g., gNB) 702 and a UE 704 according to at least one example. In some examples, the network entity 702 may further be implemented in an aggregated or monolithic base station architecture, or in a disaggregated base station architecture, and may include one or more of a central unit (CU), a distributed unit (DU), a radio unit (RU), a Near-Real Time (Near-RT) RAN Intelligent Controller (RIC), or a Non-Real Time (Non-RT) RIC. As shown, the UE 704 obtains an index 706 with a plurality of CSI reporting profiles. Each of the CSI reporting profiles may be associated with a respective number of occasions on which a CSI-RS is received by the UE during a pre-defined period of time, and/or a time length between two occasions on which CSI-RS is received. The pre-defined period of time may include a CSI measurement window Wₘₑₐₛ, which may include a period of time between a triggering PDCCH and a predetermined boundary slot. In some examples, the predetermined boundary slot may be a CSI reference resource slot, a PUSCH slot, or a last slot of a CSI measurement window Wₘₑₐₛ, as described above with reference to FIG. 6.

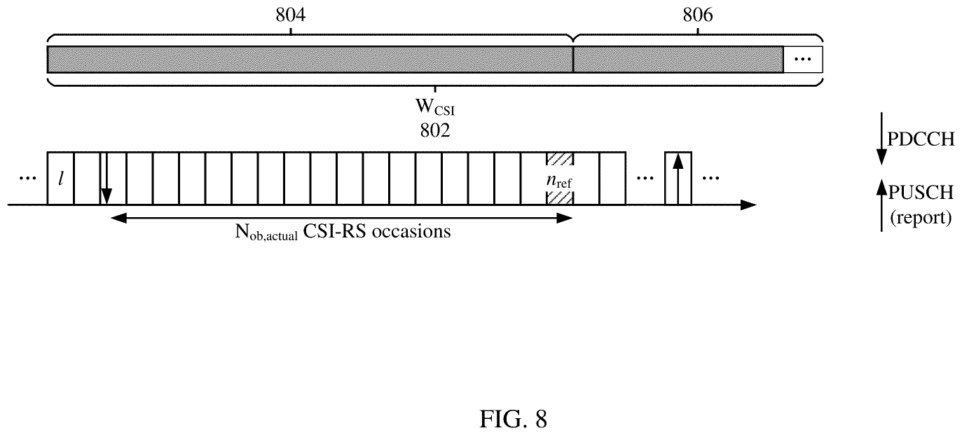

With reference to FIG. 8, the CSI reporting window W_{CSI} 802 is associated with a slot index ‘l’ and a predetermined boundary slot. As noted above with reference to FIG. 6, the boundary slot may be any one of a CSI reference resource slot n_{ref}, a PUSCH slot ‘n,’ or a last slot of the measurement window ‘k+Wₘₑₐₛ−1.’ In the example of FIG. 8, the boundary slot is the CSI reference resource slot n_{ref}. The CSI reporting window W_{CSI} 802 may include an observation period 804 and a prediction period 806. Each CSI reporting profile may be associated with a respective length of the CSI reporting window 802, a respective length of the observation period 804, and/or a respective length of the prediction period 806.

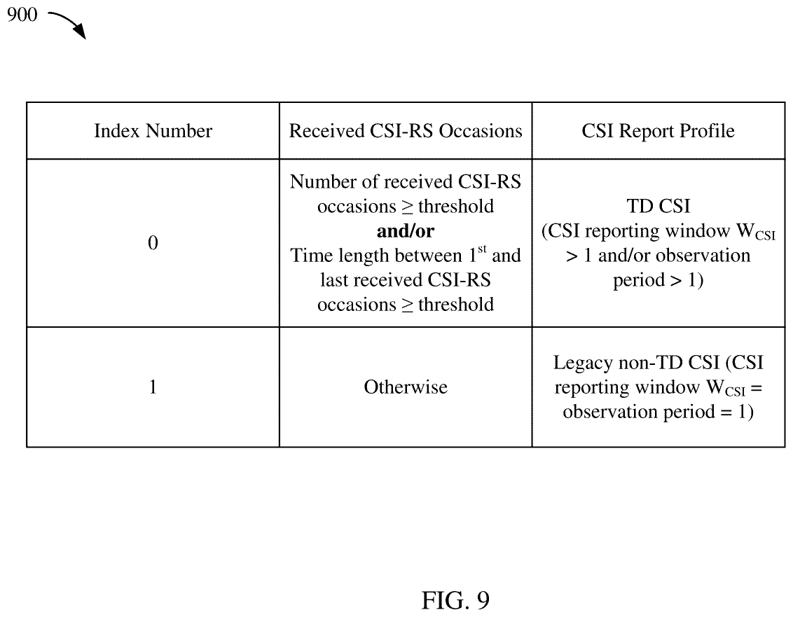

For example, FIG. 9 is a table diagram illustrating an example of an index 900 with a plurality of CSI reporting profiles. In this example, the index 900 includes two CSI reporting profiles. The first CSI reporting profile identified by the index 900 as 0 is employed by the UE 704 when the number of occasions on which CSI-RS is received is greater than or equal to a first predefined threshold. In addition, or in the alternative, the UE 704 will employ index 0 when the time length between a 1^{st} received CSI-RS and the last received CSI-RS is greater than or equal to a second predefined threshold. In such instances, the CSI report profile indicates that the UE 704 may employ a CSI report for a time domain basis with a CSI reporting window length greater than 1 and/or with a length of the observation period greater than 1.

On the other hand, when the number of occasions on which a CSI-RS is received is below the first threshold, and/or the time between the 1^{st} received CSI-RS and the last received CSI-RS is less than the second threshold, the UE 704 may employ the CSI reporting profile identified by the index 900 as 1. In this example, the CSI report profile indicates that the UE 704 may employ a legacy, non-time-domain CSI.

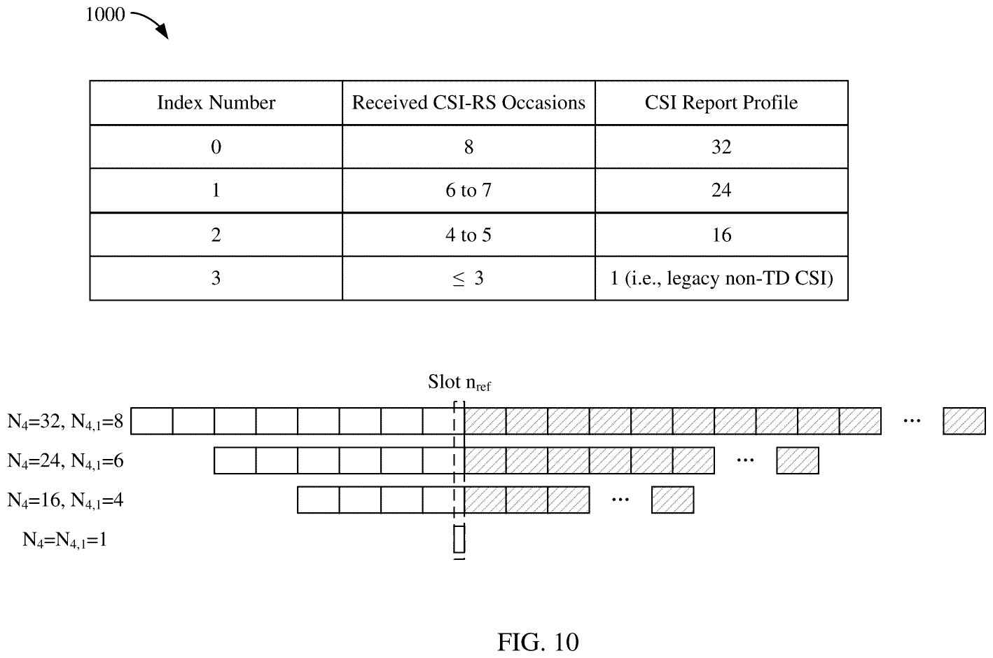

Referring now to FIG. 10, another table diagram is shown, illustrating another example of an index 1000 with a plurality of CSI reporting profiles. In this example, the first CSI reporting profile identified by the index 1000 as 0 is employed by the UE 704 when the number of occasions on which a CSI-RS is received is 8. In such instances, the CSI report profile indicates that the UE 704 is to employ a CSI report with a CSI reporting window of 32. As shown below the table, the line indicating N₄=32, N_{4,1}=8 is depicting the 8 unshaded boxes illustrating the 8 occasions on which a CSI-RS is received in the observation period of the CSI reporting window, and the shaded boxes after the boundary slot (i.e., the CSI reference resource slot n_{ref}) represent the 24 predicted CSI-RS occasions in the prediction period of the CSI reporting window.

Continuing in the example of FIG. 10, the second CSI reporting profile identified by the index 1000 as 1 is employed by the UE 704 when the number of occasions on which a CSI-RS is received is 6 or 7. In such instances, the CSI report profile indicates that the UE 704 is to employ a CSI report with a CSI reporting window of 24. As shown below the table, the line indicating N₄=24, N_{4,1}=6 is depicting the 6 unshaded boxes illustrating the 6 (or 7) occasions on which a CSI-RS is received in the observation period of the CSI reporting window, and the shaded boxes after the boundary slot (i.e., the CSI reference resource slot n_{ref}) represent the 18 predicted CSI-RS occasions in the prediction period of the CSI reporting window.

The third CSI reporting profile identified by the index 1000 as 2 is employed by the UE 704 when the number of occasions on which a CSI-RS is received is 4 or 5. In such instances, the CSI report profile indicates that the UE 704 is to employ a CSI report with a CSI reporting window of 16. As shown below the table, the line indicating N₄=16, N_{4,1}=4 is depicting the 4 unshaded boxes illustrating 4 (or 5) received CSI-RS occasions in the observation period of the CSI reporting window, and the shaded boxes after the boundary slot (i.e., the CSI reference resource slot n_{ref}) represent the 12 predicted CSI-RS occasions in the prediction period of the CSI reporting window.

Finally, the fourth CSI reporting profile identified by the index 1000 as 3 is employed by the UE 704 when the number of occasions on which a CSI-RS is received is 3 or fewer. In such instances, the CSI report profile indicates that the UE 704 is to employ a legacy non-time-domain CSI.

Referring back to FIG. 7, after the UE 704 has obtained an index 706, the network entity 702 may transmit a CSI-RS on a plurality of occasions, where on at least one occasion a CSI-RS may be received by the UE 704. For instance, in the example in FIG. 6, the network entity 702 is transmitting a CSI-RS on four occasions during the CSI measurement window Wₘₑₐₛ, of which one, two, three, or all four may be received by the UE 704.

The UE 704 may then determine 710 or identify a CSI reporting profile from the index that is associated with one or more aspects of the occasions on which a CSI-RS is received. For example, as noted above, the UE 704 may determine a CSI reporting profile from the index 900, 1000 based on the number of occasions on which a CSI-RS is received and/or the time length between at least two occasions on which a CSI-RS is received.

After the UE has identified the correct CSI reporting profile from the index, the UE 704 can generate 712 a CSI report according to the CSI reporting profile indicated by the index. In some instances, the network entity 702 and the UE 704 may have an unaligned understanding of the number of occasions on which a CSI-RS is actually received by the UE 704. For example, in a TDD system, for P-CSI-RS with an occasion transmitted on flexible symbols configured by RRC, the CSI-RS occasion may be unavailable or not received if a DCI indicates to the UE 704 to do UL transmission on these symbols, or if dynamic slot format indicator (SCI) DCI indicates these symbols as UL symbols. Accordingly, some examples of a CSI report may include a report by the UE 704 to the network entity 702 of the determined CSI reporting profile utilized for sending the CSI report. In at least one example, the UE 704 may indicate the determined CSI reporting profile utilized for sending the CSI report by sending the index of the utilized CSI reporting profile. In one or more other examples, the UE 704 may indicate the determined CSI reporting profile utilized for sending the CSI report by sending the number of occasions on which a CSI-RS is actually received and/or the time length between the first received CSI-RS occasion and the last received CSI-RS occasion. In yet one or more additional examples, the UE 704 may indicate the determined CSI reporting profile utilized for sending the CSI report by sending a transmission identifying the actual received CSI-RS occasions (e.g., with a bitmap sized according to the maximum possible number of occasions on which a CSI-RS is received after a triggering PDCCH and not later than the predetermined boundary slot).

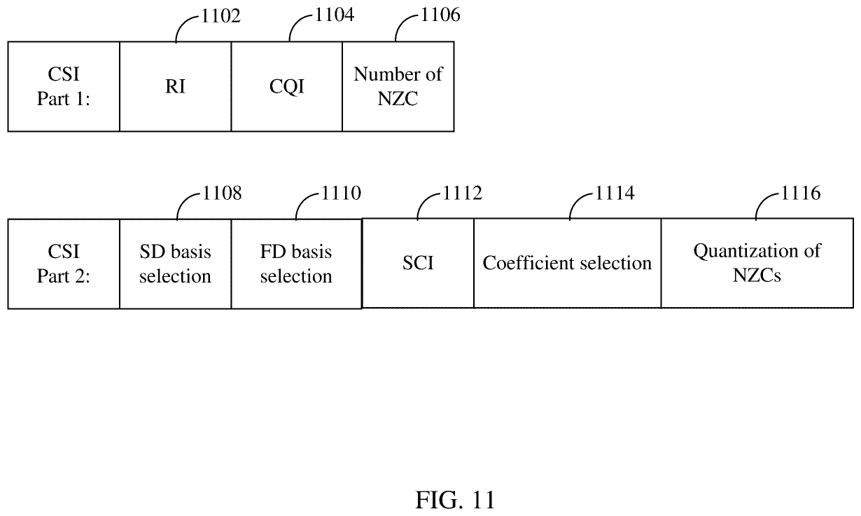

A CSI report may include at least two parts. FIG. 11 is a schematic diagram illustrating the two parts of a CSI report. As shown, part 1 may include a rank indicator (RI) 1102, channel quality information (CQI) 1104, and a number of non-zero coefficients (NZCs) 1106. The RI 1102 and number of NZCs 1106 may be utilized to determine the payload size of part 2 of the CSI. That is, the network entity 702 can determine the payload size of part 2 based on the decoded rank from the RI 1102 and the decoded total number of NZCs 1106.

Part 2 of the CSI may include a SD basis selection 1108 for selecting ‘L’ beams out of a total number of beams for W₁ of the precoding matrix ‘W.’ A FD basis selection 1110 is also included for selecting ‘M’ FD bases out of a plurality of bases for W_{f} per layer of the precoding matrix ‘W.’ An SCI 1112 is included, where the SCI (strongest coefficient indication) 1112 indicates the locations of the strongest coefficient in W₂ per layer. A coefficient selection 1114 is included, where the coefficient selection 1114 indicates by bitmap the location of NZCs within W₂ for each layer. Finally, a quantization of NZCs 1116 is included to indicate the amplitude/phase quantization for NZCs for each layer.

According to an aspect of the present disclosure, the CSI report can include an additional part, which may be referred to herein at part 0 of the CSI, that is conveyed prior to part 1 of the CSI. Part 0 of the CSI may include the indication of the determined CSI reporting profile utilize for sending the CSI report, as described above. In some examples part 0 of the CSI may be configured such that the network entity 702 can determine the payload size of part 1 of the CSI after decoding part 0 of the CSI.

In some examples, the CSI report may be configured to include the indication of the determined CSI reporting profile utilize for sending the CSI report in part 1 of the CSI. In some examples, the payload size for the indication of the determined CSI reporting profile is maintained at a constant payload size for different CSI reporting profiles to keep part 1 of the CSI at a fixed payload size. In other examples, the payload size of the RI 1102, CQI 1104, and number of NZCs 1106 is taken in account to determine a maximum possible payload size with the indication of the determined CSI reporting profile, where padding bits can be utilized in part 1 of the CSI when the indication of the determined CSI reporting profile is smaller than the maximum possible payload size value for part 1.

Referring again to FIG. 7, with the CSI report generated, the UE 704 sends 714 the CSI report to the network entity 702. In various examples the UE 704 may perform the precoding matrix prediction, which predictions are included in the sent CSI reports. In other examples, the network entity 702 may perform 716 the precoding matrix prediction based on the received CSI report from the UE 704.

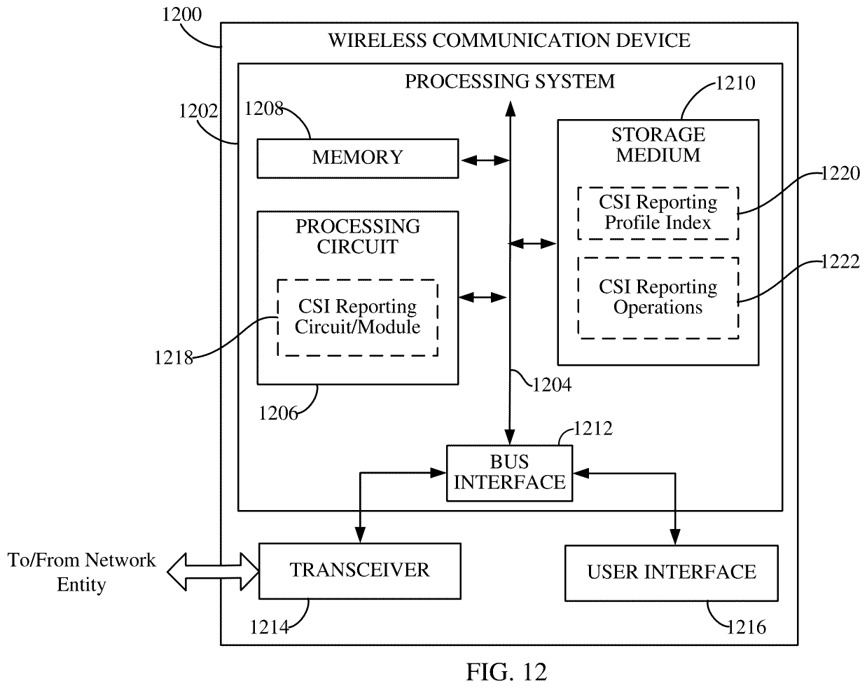

FIG. 12 is a block diagram illustrating select components of a wireless communication device 1200 employing a processing system 1202 according to at least one example of the present disclosure. The wireless communication device 1200 may be a UE or a scheduled entity as illustrated in any one or more of FIGS. 1, 2, 3, 5, and/or 7.

In this example, the processing system 1202 is implemented with a bus architecture, represented generally by the bus 1204. The bus 1204 may include any number of interconnecting buses and bridges depending on the specific application of the processing system 1202 and the overall design constraints. The bus 1204 communicatively couples together various circuits including one or more processors (represented generally by the processing circuit 1206), a memory 1208, and computer-readable media (represented generally by the storage medium 1210). The bus 1204 may also link various other circuits such as timing sources, peripherals, voltage regulators, and power management circuits, which are well known in the art, and therefore, will not be described any further. A bus interface 1212 provides an interface between the bus 1204 and a transceiver 1214. The transceiver 1214 provides a means for communicating with various other apparatus over a transmission medium. The transceiver 1214 may also include a transmit chain to transmit one or more wireless signals via the antenna array. For example, the transceiver 1214 may include a receive chain to receive one or more wireless signals, and/or a transmit chain to transmit one or more wireless signals. Depending upon the nature of the apparatus, a user interface 1216 (e.g., keypad, display, speaker, microphone, joystick) may also be provided.

The processing circuit 1206 is responsible for managing the bus 1204 and general processing, including the execution of programming stored on the computer-readable storage medium 1210. The programming, when executed by the processing circuit 1206, causes the processing system 1202 to perform the various functions described below for any particular apparatus. The computer-readable storage medium 1210 and the memory 1208 may also be used for storing data that is manipulated by the processing circuit 1206 when executing programming. As used herein, the term “programming” shall be construed broadly to include without limitation instructions, instruction sets, code, code segments, program code, programs, subprograms, software modules, applications, software applications, software packages, routines, subroutines, objects, executables, threads of execution, procedures, functions, etc., whether referred to as software, firmware, middleware, microcode, hardware description language, or otherwise.

The processing circuit 1206 is arranged to obtain, process and/or send data, control data access and storage, issue commands, and control other desired operations. The processing circuit 1206 may include circuitry adapted to implement desired programming provided by appropriate media, and/or circuitry adapted to perform one or more functions described in this disclosure. For example, the processing circuit 1206 may be implemented as one or more processors, one or more controllers, and/or other structure configured to execute executable programming and/or execute specific functions. Examples of the processing circuit 1206 may include a general purpose processor, a digital signal processor (DSP), an application specific integrated circuit (ASIC), a field programmable gate array (FPGA) and/or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 1206 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 1206 are for illustration and other suitable configurations within the scope of the present disclosure are also contemplated.

In some instances, the processing circuit 1206 may include a CSI reporting circuit and/or module 1218. The CSI reporting circuit 1218 may generally include circuitry and/or programming (e.g., programming stored on the storage medium 1210) adapted to obtain an index including a plurality of CSI reporting profiles, receive a CSI-RS on at least one occasion over a pre-defined period of time, determine a CSI reporting profile from the index, and send a CSI report associated with the determined CSI reporting profile.

The storage medium 1210 may represent one or more computer-readable devices for storing programming, such as processor executable code or instructions (e.g., software, firmware), electronic data, databases, or other digital information. The storage medium 1210 may also be used for storing data that is manipulated by the processing circuit 1206 when executing programming. The storage medium 1210 may be any available non-transitory media that can be accessed by a general purpose or special purpose processor, including portable or fixed storage devices, optical storage devices, and various other mediums capable of storing, containing and/or carrying programming. By way of example and not limitation, the storage medium 1210 may include a non-transitory computer-readable storage medium such as a magnetic storage device (e.g., hard disk, floppy disk, magnetic strip), an optical storage medium (e.g., compact disk (CD), digital versatile disk (DVD)), a smart card, a flash memory device (e.g., card, stick, key drive), random access memory (RAM), read only memory (ROM), programmable ROM (PROM), erasable PROM (EPROM), electrically erasable PROM (EEPROM), a register, a removable disk, and/or other mediums for storing programming, as well as any combination thereof.

The storage medium 1210 may be coupled to the processing circuit 1206 such that the processing circuit 1206 can read information from, and write information to, the storage medium 1210. That is, the storage medium 1210 can be coupled to the processing circuit 1206 so that the storage medium 1210 is at least accessible by the processing circuit 1206, including examples where the storage medium 1210 is integral to the processing circuit 1206 and/or examples where the storage medium 1210 is separate from the processing circuit 1206 (e.g., resident in the processing system 1202, external to the processing system 1202, distributed across multiple entities).

Programming stored by the storage medium 1210, when executed by the processing circuit 1206, can cause the processing circuit 1206 to perform one or more of the various functions and/or process steps described herein. In at least some examples, the storage medium 1210 may include a CSI reporting profile index 1220 and CSI reporting operations 1222. The CSI reporting profile index 1220 may include a plurality of CSI reporting profiles, each associated with at least one of a respective number of occasions on which a CSI-RS is received during a pre-defined period of time or a time length between two occasions on which a CSI-RS is received, as described herein. The CSI reporting operations 1222 are generally adapted to cause the processing circuit 1206 to receive at least one CSI-RS over a pre-defined period of time, determine a CSI reporting profile from the CSI reporting profile index 1220, and send a CSI report associated with the determined CSI reporting profile, as described herein.

Thus, according to one or more aspects of the present disclosure, the processing circuit 1206 is configured to perform (independently or in conjunction with the storage medium 1210) any or all of the processes, functions, steps and/or routines for any or all of the UEs and/or scheduled entities described herein.

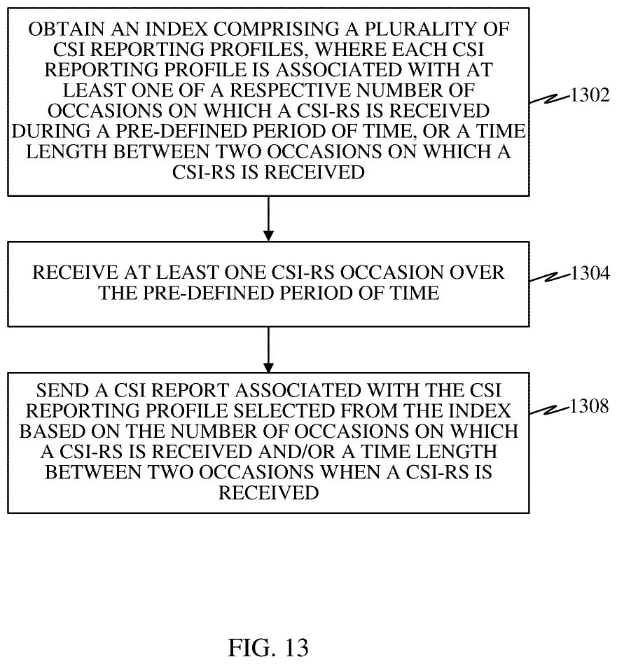

FIG. 13 is a flow diagram illustrating a wireless communication method according to some examples. A wireless communication device may obtain, at step 1302, an index including a plurality of CSI reporting profiles. Each CSI reporting profile may be associated with at least one of a respective number of occasions on which a CSI-RS is received during a pre-defined period of time or a time length between two occasions on which a CSI-RS is received. For example, the wireless communication device 1200 may be pre-provisioned with the CSI reporting profile index 1220 or may receive the CSI reporting profile index 1220 from a network entity.

As described herein, the predefined period of time may include a period of time between a triggering PDCCH and a predetermined boundary slot. The predetermined boundary slot may be a CSI reference resource slot, a PUSCH slot, or a last slot of a measurement window.

As also described herein, each CSI reporting profile may indicate at least one of a respective length of a CSI reporting window, a respective observation period of the CSI reporting window, or a respective prediction period of the CSI reporting window.

At 1304, the wireless communication device may receive a CSI-RS on at least one occasion over the pre-defined period of time. For example, the processing system 1202 may include logic (e.g., CSI reporting circuit/module 1218) to receive a CSI-RS on at least one occasion via the transceiver 1214 over the pre-defined period of time.

At 1308, the wireless communication device may send a CSI report associated with a CSI reporting profile selected from the index based on the number of occasions on which a CSI-RS is received and/or a time length between two occasions when a CSI-RS is received. For example, the processing system 1202 may include logic (e.g., CSI reporting circuit/module 1218) to generate and send, via the transceiver 1214, a CSI report associated with the CSI reporting profile selected from the index based on the number of occasions on which a CSI-RS is received and/or a time length between two occasions when a CSI-RS is received.

In some examples, the CSI report may include an indication of the determined CSI reporting profile utilized for sending the CSI report. As described herein, the indication of the determined CSI reporting profile may include an index of the determined CSI reporting profile, an indication of the number of occasions on which a CSI-RS is received over the pre-defined period of time, or a transmission identifying the occasions on which a CSI-RS is received.

In some examples, sending the CSI report may include sending the CSI report including a first part for including the indication of the determined CSI reporting profile utilized for sending the CSI report, and a second part including a RI, a CQI, and a number of NZCs. In some examples, the first part may indicate the payload size of the second part.

In some examples, sending the CSI report may include sending the CSI report including a first part with a RI, CQI, a number of NZCs, and the indication of the determined CSI reporting profile utilized for sending the CSI report. In some examples, a payload size for the first part may be constant.

The following provides an overview of aspects of the present disclosure:

Aspect 1: A wireless communication device, comprising a transceiver, a memory, and a processor communicatively coupled to the transceiver and the memory, the processor configured to obtain an index comprising a plurality of channel state information (CSI) reporting profiles, wherein each CSI reporting profile is associated with at least one of a respective number of occasions on which a CSI-reference signal (CSI-RS) is received during a pre-defined period of time, or a time length between two occasions on which a CSI-RS is received, receive via the transceiver a CSI-RS on at least one occasion over the pre-defined period of time; and send via the transceiver a CSI report associated with a CSI reporting profile selected from the index based on at least one of the number of occasions on which a CSI-RS is received or a time length between two occasions when a CSI-RS is received.

Aspect 2: The wireless communication device of aspect 1, wherein the predefined period of time comprises a period of time between a triggering PDCCH and a predetermined boundary slot.

Aspect 3: The wireless communication device of aspect 2, wherein the predetermined boundary slot is a CSI reference resource slot, a PUSCH slot, or a last slot of a measurement window.

Aspect 4: The wireless communication device of any of aspects 1 through 3, wherein each CSI reporting profile indicates at least one of a respective length of a CSI reporting window, a respective observation period of the CSI reporting window, or a respective prediction period of the CSI reporting window.

Aspect 5: The wireless communication device of any of aspects 1 through 4, wherein the processor configured to send via the transceiver a CSI report associated with the CSI reporting profile selected from the index comprises the processor configured to send an indication of the selected CSI reporting profile utilized for sending the CSI report.

Aspect 6: The wireless communication device of any of aspects 1 through 5, wherein the processor configured to send the indication of the selected CSI reporting profile utilized for the sending the CSI report comprises the processor configured to send the index of the selected CSI reporting profile.

Aspect 7: The wireless communication device of any of aspects 1 through 5, wherein the processor configured to send the indication of the selected CSI reporting profile utilized for the sending the CSI report comprises the processor configured to send an indication of the number of occasions on which a CSI-RS is received over the pre-defined period of time.

Aspect 8: The wireless communication device of any of aspects 1 through 5, wherein the processor configured to send the indication of the selected CSI reporting profile utilized for the sending the CSI report comprises the processor configured to send a transmission identifying each of the occasions that a CSI-RS is received.

Aspect 9: The wireless communication device of any of aspects 1 through 8, wherein the processor configured to send via the transceiver a CSI report associated with the CSI reporting profile selected from the index comprises the processor configured to send the CSI report including a first part for including the indication of the selected CSI reporting profile utilized for sending the CSI report, and a second part including a rank indicator, a channel quality information (CQI), and a number of non-zero coefficients, wherein the first part indicates the payload size of the second part.

Aspect 10: The wireless communication device of any of aspects 1 through 8, wherein the processor configured to send via the transceiver a CSI report associated with the CSI reporting profile selected from the index comprises the processor configured to send the CSI report including a first part comprising a rank indicator, channel quality information (CQI), a number of non-zero coefficients, and the indication of the selected CSI reporting profile utilized for sending the CSI report, wherein a payload size for the first part is constant.

Aspect 11: The wireless communication device of any of aspects 1 through 10, wherein the CSI reporting profile selected from the index indicates a legacy non-time-domain CSI report.

Aspect 12: A method of wireless communication, comprising obtaining an index comprising a plurality of channel state information (CSI) reporting profiles, wherein each CSI reporting profile is associated with at least one of a respective number of occasions on which a CSI-reference signal (CSI-RS) is received during a pre-defined period of time, or a time length between two occasions on which a CSI-RS is received, receiving a CSI-RS on at least one occasion over the pre-defined period of time; and sending a CSI report associated with a CSI reporting profile selected from the index based on at least one of the number of occasions on which a CSI-RS is received or a time length between two occasions when a CSI-RS is received.

Aspect 13: The method of aspect 12, wherein the predefined period of time comprises a period of time between a triggering PDCCH and a predetermined boundary slot.

Aspect 14: The method of any of aspect 13, wherein the predetermined boundary slot is a CSI reference resource slot, a PUSCH slot, or a last slot of a measurement window.

Aspect 15: The method of any of aspects 12 through 14, wherein each CSI reporting profile indicates at least one of a respective length of a CSI reporting window, a respective observation period of the CSI reporting window, or a respective prediction period of the CSI reporting window

Aspect 16: The method of any of aspects 12 through 15, wherein sending the CSI report associated with the CSI reporting profile selected from the index comprises sending an indication of the selected CSI reporting profile utilized for sending the CSI report.

Aspect 17: The method of any of aspects 12 through 16, wherein sending the indication of the selected CSI reporting profile utilized for sending the CSI report comprises sending the index of the selected CSI reporting profile.

Aspect 18: The method of any of aspects 12 through 16, wherein sending the indication of the selected CSI reporting profile utilized for sending the CSI report comprises sending an indication of the number of occasions on which a CSI-RS is received over the pre-defined period of time.

Aspect 19: The method of any of aspects 12 through 16, wherein sending the indication of the selected CSI reporting profile utilized for sending the CSI report comprises sending a transmission identifying each of the occasions on which a CSI-RS is received.

Aspect 20: The method of any of aspects 12 through 19, wherein sending the CSI report associated with the CSI reporting profile selected from the index comprises sending the CSI report including a first part for including the indication of the selected CSI reporting profile utilized for sending the CSI report, and a second part including a rank indicator, a channel quality information (CQI), and a number of non-zero coefficients, wherein the first part indicates the payload size of the second part.

Aspect 21: The method of any of aspects 12 through 19, wherein sending the CSI report associated with the CSI reporting profile selected from the index comprises sending the CSI report including a first part comprising a rank indicator, a channel quality information (CQI), a number of non-zero coefficients, and the indication of the selected CSI reporting profile utilized for sending the CSI report, wherein a payload size for the first part is constant.

Aspect 22: An apparatus for wireless communication, comprising means for obtaining an index comprising a plurality of channel state information (CSI) reporting profiles, wherein each CSI reporting profile is associated with at least one of a respective number of occasions on which a CSI-reference signal (CSI-RS) is received during a pre-defined period of time, or a time length between two occasions on which a CSI-RS is received, means for receiving a CSI-RS on at least one occasion over the pre-defined period of time; and means for sending a CSI report associated with a CSI reporting profile selected from the index based on at least one of the number of occasions on which a CSI-RS is received or a time length between two occasions when a CSI-RS is received.

Aspect 23: The apparatus of aspect 22, wherein the predefined period of time comprises a period of time between a triggering PDCCH and a predetermined boundary slot.

Aspect 24: The apparatus of aspect 23, wherein the predetermined boundary slot is a CSI reference resource slot, a PUSCH slot, or a last slot of a measurement window.

Aspect 25: The apparatus of any of aspects 22 through 24, wherein each CSI reporting profile indicates at least one of a respective length of a CSI reporting window, a respective observation period of the CSI reporting window, or a respective prediction period of the CSI reporting window.

Aspect 26: The apparatus of any of aspects 22 through 24, wherein sending the CSI report associated with the determined CSI reporting profile from the index comprises sending an indication of the determined CSI reporting profile utilized for sending the CSI report.

Aspect 27: The apparatus of any of aspects 22 through 26, wherein the means for sending the indication of the selected CSI reporting profile utilized for sending the CSI report comprises means for sending the index of the selected CSI reporting profile.

Aspect 28: The apparatus of any of aspects 22 through 26, wherein the means for sending the indication of the selected CSI reporting profile utilized for sending the CSI report comprises means for sending an indication of the number of occasions on which a CSI-RS is received over the pre-defined period of time.

Aspect 29: The apparatus of any of aspects 22 through 26, wherein the means for sending the indication of the selected CSI reporting profile utilized for sending the CSI report comprises means for sending a transmission identifying each of the occasions on which a CSI-RS is received.

Aspect 30: The apparatus of any of aspects 22 through 29, wherein the means for sending the CSI report associated with the CSI reporting profile selected from the index comprises means for sending the CSI report including a first part for including the indication of the selected CSI reporting profile utilized for sending the CSI report, and a second part including a rank indicator, a channel quality information (CQI), and a number of non-zero coefficients, wherein the first part indicates the payload size of the second part.

Aspect 31: The apparatus of any of aspects 22 through 29, wherein the means for sending the CSI report associated with the CSI reporting profile selected from the index comprises means for sending the CSI report including a first part comprising a rank indicator, a channel quality information (CQI), a number of non-zero coefficients, and the indication of the selected CSI reporting profile utilized for sending the CSI report, wherein a payload size for the first part is constant.

Aspect 32: A non-transitory processor-readable storage medium storing processor-executable instructions for causing a processing circuit to obtain an index comprising a plurality of channel state information (CSI) reporting profiles, wherein each CSI reporting profile is associated with at least one of a respective number of occasions on which a CSI-reference signal (CSI-RS) is received during a pre-defined period of time, or a time length between two occasions on which a CSI-RS is received, receive a CSI-RS on at least one occasion over the pre-defined period of time; and send a CSI report associated with a CSI reporting profile selected from the index based on at least one of the number of occasions on which a CSI-RS is received or a time length between two occasions when a CSI-RS is received.

Aspect 33: The processor-readable storage medium of aspect 32, wherein the predefined period of time comprises a period of time between a triggering PDCCH and a predetermined boundary slot.

Aspect 34: The processor-readable storage medium of aspect 33, wherein the predetermined boundary slot is a CSI reference resource slot, a PUSCH slot, or a last slot of a measurement window.

Aspect 35: The processor-readable storage medium of any of aspects 32 through 34, wherein each CSI reporting profile indicates at least one of a respective length of a CSI reporting window, a respective observation period of the CSI reporting window, or a respective prediction period of the CSI reporting window.

Aspect 36: The processor-readable storage medium of any of aspects 32 through 35, wherein the processor-executable instructions for causing a processing circuit to send a CSI report associated with the CSI reporting profile selected from the index comprises processor-executable instructions for causing a processing circuit to send an indication of the selected CSI reporting profile utilized for sending the CSI report.

Aspect 37: The processor-readable storage medium of any of aspects 32 through 36, wherein the processor-executable instructions for causing a processing circuit to send the indication of the selected CSI reporting profile utilized for the sending the CSI report comprises the processor-executable instructions for causing a processing circuit to send the index of the selected CSI reporting profile.

Aspect 38: The processor-readable storage medium of any of aspects 32 through 36, wherein the processor-executable instructions for causing a processing circuit to send the indication of the selected CSI reporting profile utilized for the sending the CSI report comprises the processor-executable instructions for causing a processing circuit to send an indication of the number of occasions on which a CSI-RS is received over the pre-defined period of time.

Aspect 39: The processor-readable storage medium of any of aspects 32 through 36, wherein the processor-executable instructions for causing a processing circuit to send the indication of the selected CSI reporting profile utilized for the sending the CSI report comprises the processor-executable instructions for causing a processing circuit to send a transmission identifying each of the occasions on which a CSI-RS is received.

Aspect 40: The processor-readable storage medium of any of aspects 32 through 39, wherein the processor-executable instructions for causing a processing circuit to send the CSI report associated with the CSI reporting profile selected from the index comprises the processor-executable instructions for causing a processing circuit to send the CSI report including a first part for including the indication of the selected CSI reporting profile utilized for sending the CSI report, and a second part including a rank indicator, a channel quality information (CQI), and a number of non-zero coefficients, wherein the first part indicates the payload size of the second part.

Aspect 41: The processor-readable storage medium of any of aspects 32 through 39, wherein the processor-executable instructions for causing a processing circuit to send the CSI report associated with the CSI reporting profile selected from the index comprises the processor-executable instructions for causing a processing circuit to send the CSI report including a first part comprising a rank indicator, a channel quality information (CQI), a number of non-zero coefficients, and the indication of the selected CSI reporting profile utilized for sending the CSI report, wherein a payload size for the first part is constant.

Several aspects of a wireless communication network have been presented with reference to an exemplary implementation. As those skilled in the art will readily appreciate, various aspects described throughout this disclosure may be extended to other telecommunication systems, network architectures and communication standards.

By way of example, various aspects may be implemented within other systems defined by 3GPP or combinations of such systems. These systems may include candidates such as 5G New Radio (NR), Long-Term Evolution (LTE), the Evolved Packet System (EPS), the Universal Mobile Telecommunication System (UMTS), and/or the Global System for Mobile (GSM). Various aspects may also be extended to systems defined by the 3rd Generation Partnership Project 2 (3GPP2), such as CDMA2000 and/or Evolution-Data Optimized (EV-DO). Other examples may be implemented within systems employing IEEE 802.11 (Wi-Fi), IEEE 802.16 (WIMAX), IEEE 802.20, Ultra-Wideband (UWB), Bluetooth, and/or other suitable systems. The actual telecommunication standard, network architecture, and/or communication standard employed will depend on the specific application and the overall design constraints imposed on the system.

Within the present disclosure, the word “exemplary” is used to mean “serving as an example, instance, or illustration.” Any implementation or aspect described herein as “exemplary” is not necessarily to be construed as preferred or advantageous over other aspects of the disclosure. Likewise, the term “aspects” does not require that all aspects of the disclosure include the discussed feature, advantage or mode of operation. The term “coupled” is used herein to refer to the direct or indirect coupling between two objects. For example, if object A physically touches object B, and object B touches object C, then objects A and C may still be considered coupled to one another-even if they do not directly physically touch each other. For instance, a first object may be coupled to a second object even though the first object is never directly physically in contact with the second object. The terms “circuit” and “circuitry” are used broadly, and intended to include both hardware implementations of electrical devices and conductors that, when connected and configured, enable the performance of the functions described in the present disclosure, without limitation as to the type of electronic circuits, as well as software implementations of information and instructions that, when executed by a processor, enable the performance of the functions described in the present disclosure.

While the above discussed aspects, arrangements, and embodiments are discussed with specific details and particularity, one or more of the components, steps, features and/or functions illustrated in FIGS. 1, 2, 3, 4, 5, 6, 7, 8, 9, 10, 11, 12, and/or 13 may be rearranged and/or combined into a single component, step, feature or function or embodied in several components, steps, or functions. Additional elements, components, steps, and/or functions may also be added or not utilized without departing from the novel features of the present disclosure. The apparatus, devices and/or components illustrated in FIGS. 1, 2, 3, 5, 7, and/or 12 may be configured to perform or employ one or more of the methods, features, parameters, and/or steps described herein with reference to FIGS. 4, 6, 7, 8, 9, 10, 11, and/or 13. The novel algorithms described herein may also be efficiently implemented in software and/or embedded in hardware.

It is to be understood that the specific order or hierarchy of steps in the methods disclosed is an illustration of exemplary processes. Based upon design preferences, it is understood that the specific order or hierarchy of steps in the methods may be rearranged. The accompanying method claims present elements of the various steps in a sample order, and are not meant to be limited to the specific order or hierarchy presented unless specifically recited therein.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. A wireless communication device, comprising:
a transceiver;
a memory; and
a processor communicatively coupled to the transceiver and the memory, the processor configured to:
obtain an index comprising a plurality of channel state information (CSI) reporting profiles, wherein each CSI reporting profile is associated with at least one of a respective number of occasions on which a CSI-reference signal (CSI-RS) is received during a pre-defined period of time, or a time length between two occasions on which a CSI-RS is received;
receive via the transceiver a CSI-RS on at least one occasion over the pre-defined period of time; and
send via the transceiver a CSI report associated with a CSI reporting profile selected from the index based on at least one of the number of occasions on which a CSI-RS is received or a time length between two occasions when a CSI-RS is received.

2. The wireless communication device of claim 1, wherein the predefined period of time comprises a period of time between a triggering PDCCH and a predetermined boundary slot.

3. The wireless communication device of claim 2, wherein the predetermined boundary slot is a CSI reference resource slot, a PUSCH slot, or a last slot of a measurement window.

4. The wireless communication device of claim 1, wherein each CSI reporting profile indicates at least one of a respective length of a CSI reporting window, a respective observation period of the CSI reporting window, or a respective prediction period of the CSI reporting window.

5. The wireless communication device of claim 1, wherein the processor configured to send via the transceiver a CSI report associated with the CSI reporting profile selected from the index comprises the processor configured to:
send an indication of the selected CSI reporting profile utilized for sending the CSI report.

6. The wireless communication device of claim 5, wherein the processor configured to send the indication of the selected CSI reporting profile utilized for the sending the CSI report comprises the processor configured to:
send the index of the selected CSI reporting profile.

7. The wireless communication device of claim 5, wherein the processor configured to send the indication of the selected CSI reporting profile utilized for the sending the CSI report comprises the processor configured to:
send an indication of the number of occasions on which a CSI-RS is received over the pre-defined period of time.

8. The wireless communication device of claim 5, wherein the processor configured to send the indication of the selected CSI reporting profile utilized for the sending the CSI report comprises the processor configured to:
send a transmission identifying each of the occasions that a CSI-RS is received.

9. The wireless communication device of claim 5, wherein the processor configured to send via the transceiver a CSI report associated with the CSI reporting profile selected from the index comprises the processor configured to:
send the CSI report including a first part for including the indication of the selected CSI reporting profile utilized for sending the CSI report, and a second part including a rank indicator, a channel quality information (CQI), and a number of non-zero coefficients, wherein the first part indicates the payload size of the second part.

10. The wireless communication device of claim 5, wherein the processor configured to send via the transceiver a CSI report associated with the CSI reporting profile selected from the index comprises the processor configured to:
send the CSI report including a first part comprising a rank indicator, channel quality information (CQI), a number of non-zero coefficients, and the indication of the selected CSI reporting profile utilized for sending the CSI report, wherein a payload size for the first part is constant.

11. The wireless communication device of claim 1, wherein the CSI reporting profile selected from the index indicates a legacy non-time-domain CSI report.

12. A method of wireless communication, comprising:
obtaining an index comprising a plurality of channel state information (CSI) reporting profiles, wherein each CSI reporting profile is associated with at least one of a respective number of occasions on which a CSI-reference signal (CSI-RS) is received during a pre-defined period of time, or a time length between two occasions on which a CSI-RS is received;
receiving a CSI-RS on at least one occasion over the pre-defined period of time; and
sending a CSI report associated with a CSI reporting profile selected from the index based on at least one of the number of occasions on which a CSI-RS is received or a time length between two occasions when a CSI-RS is received.

13. The method of claim 12, wherein the predefined period of time comprises a period of time between a triggering PDCCH and a predetermined boundary slot.

14. The method of claim 13, wherein the predetermined boundary slot is a CSI reference resource slot, a PUSCH slot, or a last slot of a measurement window.

15. The method of claim 12, wherein each CSI reporting profile indicates at least one of a respective length of a CSI reporting window, a respective observation period of the CSI reporting window, or a respective prediction period of the CSI reporting window.

16. The method of claim 12, wherein sending the CSI report associated with the CSI reporting profile selected from the index comprises:
sending an indication of the selected CSI reporting profile utilized for sending the CSI report.

17. The method of claim 16, wherein sending the indication of the selected CSI reporting profile utilized for sending the CSI report comprises:
sending the index of the selected CSI reporting profile.

18. The method of claim 16, wherein sending the indication of the selected CSI reporting profile utilized for sending the CSI report comprises:
sending an indication of the number of occasions on which a CSI-RS is received over the pre-defined period of time.

19. The method of claim 16, wherein sending the indication of the selected CSI reporting profile utilized for sending the CSI report comprises:
sending a transmission identifying each of the occasions on which a CSI-RS is received.

20. The method of claim 16, wherein sending the CSI report associated with the CSI reporting profile selected from the index comprises:
sending the CSI report including a first part for including the indication of the selected CSI reporting profile utilized for sending the CSI report, and a second part including a rank indicator, a channel quality information (CQI), and a number of non-zero coefficients, wherein the first part indicates the payload size of the second part.

21. The method of claim 16, wherein sending the CSI report associated with the CSI reporting profile selected from the index comprises:
sending the CSI report including a first part comprising a rank indicator, a channel quality information (CQI), a number of non-zero coefficients, and the indication of the selected CSI reporting profile utilized for sending the CSI report, wherein a payload size for the first part is constant.

22. An apparatus for wireless communication, comprising:
means for obtaining an index comprising a plurality of channel state information (CSI) reporting profiles, wherein each CSI reporting profile is associated with at least one of a respective number of occasions on which a CSI-reference signal (CSI-RS) is received during a pre-defined period of time, or a time length between two occasions on which a CSI-RS is received;
means for receiving a CSI-RS on at least one occasion over the pre-defined period of time; and
means for sending a CSI report associated with a CSI reporting profile selected from the index based on at least one of the number of occasions on which a CSI-RS is received or a time length between two occasions when a CSI-RS is received.

23. The apparatus of claim 22, wherein the predefined period of time comprises a period of time between a triggering PDCCH and a predetermined boundary slot.

24. The apparatus of claim 23, wherein the predetermined boundary slot is a CSI reference resource slot, a PUSCH slot, or a last slot of a measurement window.

25. The apparatus of claim 22, wherein each CSI reporting profile indicates at least one of a respective length of a CSI reporting window, a respective observation period of the CSI reporting window, or a respective prediction period of the CSI reporting window.

26. The apparatus of claim 22, wherein the means for sending the CSI report associated with the CSI reporting profile selected from the index comprises:
means for sending an indication of the selected CSI reporting profile utilized for sending the CSI report.

27. The apparatus of claim 26, wherein the means for sending the indication of the selected CSI reporting profile utilized for sending the CSI report comprises:
means for sending the index of the selected CSI reporting profile.

28. The apparatus of claim 26, wherein the means for sending the indication of the selected CSI reporting profile utilized for sending the CSI report comprises:
means for sending an indication of the number of occasions on which a CSI-RS is received over the pre-defined period of time.

29. The apparatus of claim 26, wherein the means for sending the indication of the selected CSI reporting profile utilized for sending the CSI report comprises:
means for sending a transmission identifying each of the occasions on which a CSI-RS is received.

30. The apparatus of claim 26, wherein the means for sending the CSI report associated with the CSI reporting profile selected from the index comprises:
means for sending the CSI report including a first part for including the indication of the selected CSI reporting profile utilized for sending the CSI report, and a second part including a rank indicator, a channel quality information (CQI), and a number of non-zero coefficients, wherein the first part indicates the payload size of the second part.

31. The apparatus of claim 26, wherein the means for sending the CSI report associated with the CSI reporting profile selected from the index comprises:
means for sending the CSI report including a first part comprising a rank indicator, a channel quality information (CQI), a number of non-zero coefficients, and the indication of the selected CSI reporting profile utilized for sending the CSI report, wherein a payload size for the first part is constant.

32. A non-transitory processor-readable storage medium storing processor-executable instructions for causing a processing circuit to:
obtain an index comprising a plurality of channel state information (CSI) reporting profiles, wherein each CSI reporting profile is associated with at least one of a respective number of occasions on which a CSI-reference signal (CSI-RS) is received during a pre-defined period of time, or a time length between two occasions on which a CSI-RS is received;
receive a CSI-RS on at least one occasion over the pre-defined period of time; and
send a CSI report associated with a CSI reporting profile selected from the index based on at least one of the number of occasions on which a CSI-RS is received or a time length between two occasions when a CSI-RS is received.

33. The processor-readable storage medium of claim 32, wherein the predefined period of time comprises a period of time between a triggering PDCCH and a predetermined boundary slot.

34. The processor-readable storage medium of claim 33, wherein the predetermined boundary slot is a CSI reference resource slot, a PUSCH slot, or a last slot of a measurement window.

35. The processor-readable storage medium of claim 32, wherein each CSI reporting profile indicates at least one of a respective length of a CSI reporting window, a respective observation period of the CSI reporting window, or a respective prediction period of the CSI reporting window.

36. The processor-readable storage medium of claim 32, wherein the processor-executable instructions for causing a processing circuit to send a CSI report associated with the CSI reporting profile selected from the index comprises processor-executable instructions for causing a processing circuit to:
send an indication of the selected CSI reporting profile utilized for sending the CSI report.

37. The processor-readable storage medium of claim 36, wherein the processor-executable instructions for causing a processing circuit to send the indication of the selected CSI reporting profile utilized for the sending the CSI report comprises the processor-executable instructions for causing a processing circuit to:
send the index of the selected CSI reporting profile.

38. The processor-readable storage medium of claim 36, wherein the processor-executable instructions for causing a processing circuit to send the indication of the selected CSI reporting profile utilized for the sending the CSI report comprises the processor-executable instructions for causing a processing circuit to:
send an indication of the number of occasions on which a CSI-RS is received over the pre-defined period of time.

39. The processor-readable storage medium of claim 36, wherein the processor-executable instructions for causing a processing circuit to send the indication of the selected CSI reporting profile utilized for the sending the CSI report comprises the processor-executable instructions for causing a processing circuit to:
send a transmission identifying each of the occasions on which a CSI-RS is received.

40. The processor-readable storage medium of claim 36, wherein the processor-executable instructions for causing a processing circuit to send the CSI report associated with the CSI reporting profile selected from the index comprises the processor-executable instructions for causing a processing circuit to:
send the CSI report including a first part for including the indication of the selected CSI reporting profile utilized for sending the CSI report, and a second part including a rank indicator, a channel quality information (CQI), and a number of non-zero coefficients, wherein the first part indicates the payload size of the second part.

41. The processor-readable storage medium of claim 36, wherein the processor-executable instructions for causing a processing circuit to send the CSI report associated with the CSI reporting profile selected from the index comprises the processor-executable instructions for causing a processing circuit to:
send the CSI report including a first part comprising a rank indicator, a channel quality information (CQI), a number of non-zero coefficients, and the indication of the selected CSI reporting profile utilized for sending the CSI report, wherein a payload size for the first part is constant.
